(19) United States
(12) Patent Application Publication
(10) Pub. No.: US 2026/0311069 A1
(43) Pub. Date: Oct. 8, 2026

(54) GRAPHICAL EDITOR FOR COMPLEX ARTIFICIAL INTELLIGENCE AGENT SYSTEMS

(71) Applicant: Panasonic Well LLC, Palo Alto, CA (US)

(72) Inventors: Yoky Matsuoka, Los Altos Hills, CA (US); David Justus, Brooklyn, NY (US); Sandy Anuras, Seattle, WA (US)

(21) Appl. No.: 19/339,958

(22) Filed: Sep. 25, 2025

Related U.S. Application Data
(60) Provisional application No. 63/783,795, filed on Apr. 4, 2025.

(51) Int. Cl. G06N 20/20; G06F 3/0482; G06F 11/34; G06F 11/3604

(52) U.S. Cl. CPC G06N 20/20; G06F 3/0482; G06F 11/3447; G06F 11/3612

(57) ABSTRACT

Systems and methods are implemented to provide a framework for generating artificial intelligence-based automated agents according to graphical representations of artificial intelligence processes and connections amongst these processes, which collectively define the functions of the artificial intelligence-based automated agents. Through a graphical user interface, these functions are dynamically evaluated and tested to identify any potential errors associated with the automated agents and to provide data corresponding to any intermediate operations performed by these automated agents in order to generate desired outputs. Once an automated agent is defined through the graphical user interface, the automated agent can be generated and invoked, such as through endpoint application programming interfaces (APIs).

### CROSS-REFERENCE TO RELATED APPLICATIONS

The present application claims the benefit of U.S. Provisional Application 63/783,795 filed Apr. 4, 2025 and is related to U.S. Non-Provisional Application entitled “AI AGENT PLATFORMS” filed Sep. 25, 2025 (Attorney Docket No.: 109304-855123-009600US), U.S. Non-Provisional Application entitled “METHODS AND SYSTEMS FOR SELF-HEALING ARTIFICIAL INTELLIGENCE” filed Sep. 25, 2025 (Attorney Docket No.: 109304-854309-009700US), U.S. Non-Provisional Application entitled “SYSTEMS AND METHODS FOR PROACTIVE RESPONSE GENERATION IN MULTI-USER SESSIONS” filed Sep. 25, 2025 (Attorney Docket No.: 109304-854311-009900US) and U.S. Provisional Application entitled “METHODS AND SYSTEMS FOR AGENTIC MODEL COMPRESSION” filed Sep. 25, 2025 (Attorney Docket No.: 109304-856803-010000USP), each of which are incorporated herein by reference in their entireties and for all purposes.

### FIELD

The present disclosure relates to systems and methods for generation and modification of complex automated agents through a graphical editor. Through the graphical editor, graphical user interface elements corresponding to different artificial intelligence-based functions and processes are manipulatable to define the functions of automated agents.

### SUMMARY

Disclosed embodiments provide a framework for generating artificial intelligence-based automated agents according to graphical representations of artificial intelligence processes and connections amongst these processes, which collectively define the functions of the artificial intelligence-based automated agents. According to some embodiments, a computer-implemented method is provided. The computer-implemented method comprises detecting through a graphical user interface a request to generate an automated agent. The request includes a graphical representation of a set of nodes and a set of connections amongst the set of nodes. Furthermore, the set of nodes corresponds to different machine learning models and a set of functions performable by the different machine learning models. Additionally, the set of connections defines processing paths of the automated agent. The computer-implemented method further comprises dynamically converting the graphical representation of the set of nodes and the set of connections into programmatic code. The computer-implemented method further comprises executing the programmatic code to evaluate a performance of the different machine learning models in processing the set of functions according to the processing paths. The computer-implemented method further comprises updating the graphical user interface according to the performance of the different machine learning models. The computer-implemented method further comprises detecting through the graphical user interface to implement the automated agent according to the graphical representation of the set of nodes and the set of connections. The computer-implemented method further comprises converting the programmatic code into a configuration file. The computer-implemented method further comprises exposing an application programming interface (API) endpoint corresponding to the configuration file. The API endpoint is exposed through a runtime environment (RTE). Furthermore, the RTE processes API calls to the API endpoint to execute the automated agent according to the configuration file, the set of functions, and the processing paths.

In some embodiments, the computer-implemented method further comprises detecting one or more errors corresponding to the performance of the different machine learning models. The computer-implemented method further comprises dynamically updating the graphical user interface to present the one or more errors.

In some embodiments, the computer-implemented method further comprises receiving a request to test the automated agent according to the graphical representation of the set of nodes and the set of connections. The computer-implemented method further comprises updating the graphical user interface to provide an agent interface environment. The agent interface environment is generated according to the programmatic code. The computer-implemented method further comprises providing automated agent outputs and intermediate agent operations according to inputs received through the agent interface environment.

In some embodiments, the request further includes a set of intermediate prompts. Furthermore, the set of intermediate prompts is used as input to the different machine learning models to perform the set of functions.

In some embodiments, the set of connections is defined through the graphical user interface according to different outputs generated by the different machine learning models.

In some embodiments, the computer-implemented method further comprises identifying a set of available machine learning models for defining different nodes through the graphical user interface. The computer-implemented method further comprises detecting a request to add a new node to the graphical representation of the set of nodes. The computer-implemented method further comprises updating the graphical user interface to indicate the set of available machine learning models. When a machine learning model is selected from the set of available machine learning models, the machine learning model is associated with the new node.

In some embodiments, the computer-implemented method further comprises receiving a request to evaluate the programmatic code. The computer-implemented method further comprises updating the graphical user interface to present the programmatic code. When a modification to the programmatic code made through the graphical user interface, the graphical representation of the set of nodes and the set of connections is dynamically updated according to the modification.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which an automated agent is defined and generated through user manipulation of different graphical elements corresponding to artificial intelligence-based functions and processes in accordance with at least one embodiment;

FIG. 2 shows an illustrative example of an environment in which an agent generation system, through an agent evaluation module, processes user interactions with an agent generator interface to evaluate and generate an automated agent in accordance with at least one embodiment;

FIGS. 3A-3C show an illustrative example of an environment in which different automated agent functions and processes are defined through an agent generator interface in accordance with at least one embodiment;

FIGS. 4A-4B show an illustrative example of an environment in which different automated agent functions and processes are dynamically evaluated and tested in accordance with at least one embodiment;

FIG. 5 shows an illustrative example of a process for dynamically evaluating a graphical representation of a new automated agent according to connections among different nodes representing machine learning model elements in accordance with at least one embodiment;

FIG. 6 shows an illustrative example of a process for dynamically testing a performance of an automated agent and providing data corresponding to intermediate operations performed by the automated agent in accordance with at least one embodiment;

FIG. 7 shows an illustrative example of a process for implementing a new automated agent based on a graphical representation of an automated agent configuration in accordance with at least one embodiment;

FIG. 8 shows an illustrative example of an environment in which communications with members are processed in accordance with at least one embodiment; and

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments provide a framework for generating artificial intelligence-based automated agents according to graphical representations of artificial intelligence processes and connections amongst these processes, which collectively define the functions of the artificial intelligence-based automated agents. Through a graphical user interface, these functions are dynamically evaluated and tested to identify any potential errors associated with the automated agents and to provide data corresponding to any intermediate operations performed by these automated agents in order to generate desired outputs. Once an automated agent is defined through the graphical user interface, the automated agent can be generated and invoked, such as through endpoint application programming interfaces (APIs).

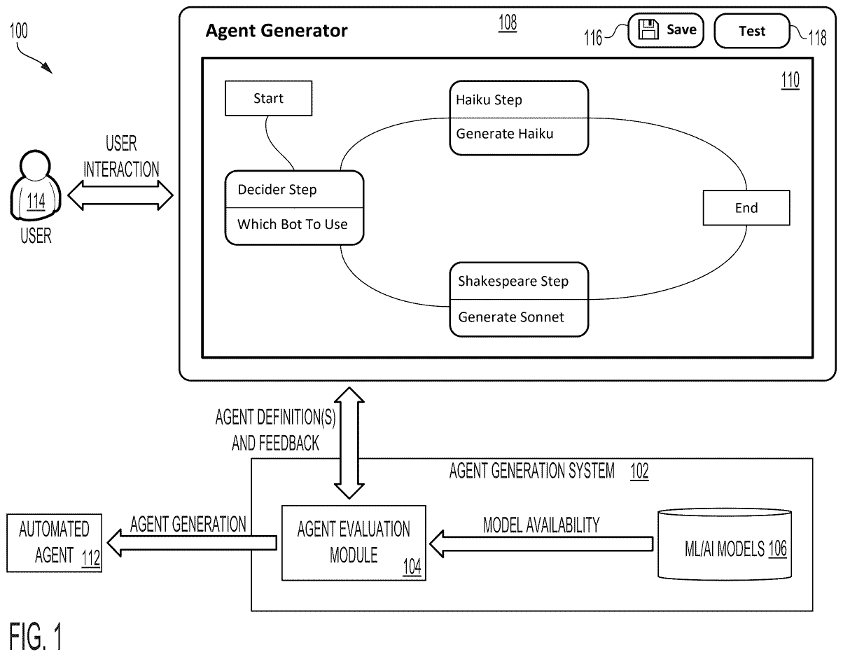

FIG. 1 shows an illustrative example of an environment 100 in which an automated agent 112 is defined and generated through user manipulation of different graphical elements corresponding to artificial intelligence-based functions and processes in accordance with at least one embodiment. In the environment 100, an agent generation system 102 implements an agent generator interface 108 through which users (such as user 114) can configure, test, and implement automated agents for the performance of different functions, as defined by these users. An automated agent, in an embodiment, is an automated process (such as a bot) that may be configured to automatically engage and interact with different entities, including users, computing devices, and other automated bots. An automated agent may be implemented by leveraging different large language models (LLMs) and/or other generative artificial intelligence processes, which may process provided prompts (e.g., requests) to identify corresponding intents and generate outputs based on these intents. These different LLMs and/or other generative artificial intelligence processes leveraged by the automated agent may each perform one or more automated functions to collectively generate an output. For instance, a particular LLM or other generative artificial intelligence process associated with an automated agent may generate an intermediate output that may be used as input to or otherwise leveraged by another LLM or other generative artificial intelligence process to generate a final output that may be provided to a user or other entity engaged with the automated agent.

In an embodiment, the agent generation system 102 provides a user 114 with an agent generator interface 108 through which the user 114 can graphically define the different functions and processes that are to be performed by an automated agent 112. For example, through an application or web portal provided by the agent generation system 102, the user 114 may be provided with the agent generator interface 108 to allow the user 114 to define these different functions and processes for a desired automated agent 112. The agent generator interface 108, in an embodiment, is a graphical user interface (GUI) through which the user 114 may dynamically interact with graphical representations of different nodes corresponding to different LLMs or other generative artificial intelligence processes that are configured, through the agent generator interface 108, to perform different functions and processes in order to generate a desired output or otherwise perform desired actions.

In an embodiment, the agent generation system 102, through the agent generator interface 108, provides the user 114 with different graphical elements that may be manipulated through the agent generator interface 108 to define an automated agent 112. For example, as illustrated in FIG. 1, the agent generation system 102, through the agent generator interface 108, may provide an agent definition window 110 through which the user 114 may add, delete, modify, or otherwise manipulate different nodes to define the functions and processes that are to be executed by the automated agent 112 in response to user requests or prompts. Additionally, through the agent generator interface 108, the agent generation system 102 may allow the user 114 to connect these different nodes to indicate the processing paths for the automated agent 112. For instance, a connection between a first node and a second node (as graphically represented through the agent definition window 110) may denote that the output of a function or process associated with the first node is to be used as input to the function or process associated with the second node.

Through the agent generator interface 108, the agent generation system 102 may automatically introduce a start node and an end node. The start node may denote a starting point for the automated agent 112, through which the automated agent 112 may receive a user prompt that is to be processed in order to generate a desired output. The end node automatically introduced through the agent generator interface 108 may denote an end point for the automated agent 112, through which the automated agent 112 may provide an output that is responsive to a user prompt or other input.

In an embodiment, the agent generation system 102, through the agent generator interface 108, further provides a set of options for introducing different nodes that may be used to define the different functions and processes associated with the automated agent 112. For example, through the agent definition window 110 of the agent generator interface 108, the agent generation system 102 may provide the user 114 with options to introduce a node corresponding to a LLM or other generative artificial intelligence process, a node corresponding to an application programming interface (API) through which a LLM or other generative artificial intelligence process may communicate with other systems, a node corresponding to a database (e.g., a vector database, a knowledge base, etc.) through which a LLM or other generative artificial intelligence may automatically process a provided input to generate an output, and the like.

When the user 114 introduces a new node through the agent definition window 110, the agent generation system 102 may allow the user 114 to configure the corresponding functions associated with the node for the automated agent 112. For example, when the user 114 introduces a node corresponding to a particular function or process that is to be performed by a particular LLM or other generative artificial intelligence process, the agent generation system 102 may dynamically update the agent definition window 110 to present, through a configuration window corresponding to the node, a set of options for configuring the LLM or other generative artificial intelligence process. Through this configuration window, the agent generation system 102 may provide the user 114 with options for selecting the LLM or other generative artificial intelligence process that is to be leveraged for performance of the particular function or process. In an embodiment, the agent generation system 102 maintains, through a models repository 106, different pre-trained LLMs or other generative artificial intelligence processes that may be leveraged by the agent generation system 102 to define an automated agent. These pre-trained LLMs or other generative artificial intelligence processes may be obtained from external and/or internal sources. For instance, the pre-trained LLMs or other generative artificial intelligence processes may include one or more open source LLMs or other generative artificial intelligence processes that may be openly available to different entities. Additionally, or alternatively, the pre-trained LLMs or other generative artificial intelligence processes may include one or more proprietary LLMs or other generative artificial intelligence processes that are generated and maintained by the agent generation system 102, a service that provides the agent generation system 102, and/or other entity that has authorized the agent generation system 102 to make the one or more proprietary LLMs or other generative artificial intelligence processes available for generation of automated agents.

In addition to providing the user 114 with a set of options for selecting the LLM or other generative artificial intelligence process for the particular function or process, the agent generation system 102, through the agent definition window 110, may provide the user 114 with an option to define a prompt that is to be processed by the selected LLM or other generative artificial intelligence process to generate a desired output. This prompt may differ from the prompt that is to be processed by the automated agent, as defined through the start node. For example, the prompt provided through the agent definition window 110 may define the function or process that the selected LLM or other generative artificial intelligence process is to perform in response to a user request (e.g., a user prompt) made to the automated agent. The prompt provided through the agent definition window 110 may thus instruct the selected LLM or other generative artificial intelligence process how to process a received user prompt. The prompt provided through the agent definition window 110 may not be visible or otherwise accessible to an end user interacting with the automated agent.

Through the agent definition window 110, the agent generation system 102 may further provide the user 114 with an option to review the programmatic code associated with the selected LLM or other generative artificial intelligence process. In an embodiment, as the user 114, through the agent definition window 110, defines the functions or processes associated with a particular LLM or other generative artificial intelligence process, the agent generation system 102, through an agent evaluation module 104, dynamically generates programmatic code that can be executed to process a provided input through the particular LLM or other generative artificial intelligence process. Through the agent definition window 110, the user 114 may review and (if needed) modify the programmatic code associated with the particular LLM or other generative artificial intelligence process to define the functionality or process corresponding to the particular LLM or other generative artificial intelligence process.

In an embodiment, when the user 114 defines a new node corresponding to a functionality or process that is to be performed by a selected LLM or other generative artificial intelligence process, the agent evaluation module 104 of the agent generation system 102 automatically evaluates the programmatic code associated with the new node to determine whether there are any errors or other issues that need to be addressed prior to the automated agent 112 being implemented. For example, the agent evaluation module 104 may automatically evaluate the programmatic code to determine whether the programmatic code includes (or otherwise results in) any syntax errors, semantic errors, logic errors, compilation errors, runtime errors, interface errors, and the like. If the agent evaluation module 104 detects any errors or other issues associated with the programmatic code associated with a particular node (e.g., a particular instance of a LLM or other generative artificial intelligence process), the agent evaluation module 104 may dynamically update the agent definition window 110 to present the detected errors or other issues. For instance, if the agent evaluation module 104 detects an error associated with the programmatic code corresponding to a particular node, the agent evaluation module 104 may update the agent definition window 110 to present the programmatic code and the location of the identified error. The identified error may be graphically represented in a manner that may be easily understood by the user 114. For example, the portion of the programmatic code associated with the identified error may be highlighted or otherwise distinguished from the other portions of the programmatic code to graphically illustrate the identified error. In some instances, the agent evaluation module 104 may additionally, or alternatively, change the font and/or font style of the programmatic code associated with the identified error. For example, the agent evaluation module 104 may change the color of the font associated with the portion of the programmatic code associated with the identified error (such as changing the color of the font from black to red, etc.). Additionally, or alternatively, the agent evaluation module 104 may italicize, underline, make bold, or otherwise emphasize the portion of the programmatic code associated with the identified error. This may allow the user, through the agent definition window 110, to readily identify the source of the identified error within the programmatic code.

In some instances, in addition to illustrating any detected errors through the agent definition window 110, the agent evaluation module 104 may further indicate the cause of the error and possible solutions for addressing the identified error. For example, if the agent evaluation module 104 determines that the programmatic code includes a syntax error, the agent evaluation module 104 may update the agent definition window 110 to expressly indicate (such as through text or other graphical representation) that the programmatic code includes a syntax error at the indicated location. This may allow the user 114 to readily determine the type of error detected by the agent evaluation module 104 and modify the programmatic code through the agent definition window 110 to address the identified error. In an embodiment, as the user 114 modifies the programmatic code through the agent definition window 110, the agent evaluation module 104 dynamically evaluates these modifications to determine whether the indicated error has been addressed and whether there are any new errors that may impact performance of the automated agent 112. Based on this evaluation, the agent evaluation module 104 may dynamically update the agent definition window 110 to remove any prior error indications (if the errors have been resolved) and/or present any newly detected errors.

The automatic detection of errors associated with an automated agent 112 prior to the automated agent 112 being implemented provides several benefits. For example, by providing an indication of a detected error through the agent generator interface 108, the user 114 may be able to readily identify the source and potential impact of the error should the automated agent 112 be implemented in the current state. This may provide the user 114 with insights as to how best to address the error and potentially make modifications to one or more nodes and corresponding processing paths associated with the automated agent 112 to improve its functionality (e.g., improve performance, speed, resource utilization, etc.). Another benefit may include preventing implementation of the automated agent 112 until the detected are addressed through the agent generator interface 108. This may prevent execution of the automated agent 112 resulting in erroneous outputs (e.g., hallucinations, incorrect results, etc.) and/or performance issues (e.g., system crashes, abnormal behaviors, inefficient resource utilizations, resource failures, etc.). In some instances, the error indications may provide the user 114 with information regarding the error without need to be adept with the programming language corresponding to the programmatic code used to define the different functions of the automated agent 112. The error indications may thus make it easier for the user 114 to understand the nature of the error and address the error through other techniques, such as through manipulation of the nodes and/or processing paths defined through the agent definition window 110.

In an embodiment, if the agent definition window 110 includes other nodes corresponding to other functions and processes of the automated agent 112, the agent generation system 102, through the agent definition window 110, further provides the user 114 with one or more options for routing the outputs of the particular LLM or other generative artificial intelligence process associated with the new node to these other nodes. For example, the agent evaluation module 104 may automatically identify the other nodes present within the agent definition window 110 and present options corresponding to these other nodes for routing of the outputs from the LLM or other generative artificial intelligence process. In an embodiment, if the user 114 defines, through selection of an option corresponding to another node, a routing path for an output of the LLM or other generative artificial intelligence process, the agent generation system 102 automatically updates the agent definition window 110 to present a connector between the node corresponding to the LLM or other generative artificial intelligence process and the other node selected by the user 114. This connector may graphically represent a connection between these nodes and may denote a processing path whereby the output of the LLM or other generative artificial process is used as input to the LLM or other generative artificial process associated with the other node. This may allow the user 114 to visually review the processing paths of the automated agent 112 as different LLMs or other generative artificial intelligence processes associated with the automated agent 112 execute their corresponding functions or processes.

As illustrated in FIG. 1, the graphical representation of the functions or processes of the automated agent 112 includes a start node, which represents an input that is obtained by the automated agent 112 from other users interacting with the automated agent 112. This input may include a user prompt or other request/command submitted to the automated agent 112. From this start node, this user prompt is provided to a node corresponding to a first functionality or process of the automated agent 112 (e.g., a decider step), whereby the automated agent 112 may process the user prompt through a selected LLM or other generative artificial intelligence process to determine which bot or other LLM/generative artificial intelligence process is to be executed to process the user prompt and generate an output. Each bot or other LLM/generative artificial intelligence process may be configured by the user 114 according to a desired function or process that is to be performed by the bot or other LLM/generative artificial intelligence process. For example, the “Haiku Step” node may correspond to a LLM or other generative intelligence process that is to process the user prompt to generate a haiku that is responsive to the provided user prompt. Similarly, the “Shakespeare Step” node may correspond to a LLM or other generative intelligence process that is to process the user prompt to generate a sonnet in the style of Shakespeare. Connectors from these nodes to the end node may denote that the outputs generated by these nodes are to be provided to the end user in response to their user prompt. Thus, through the agent definition window 110, the user 114 may readily view the processing paths of the automated agent 112, as well as add, remove, or modify any nodes and/or connections amongst nodes to further refine the processing paths of the automated agent 112.

In an embodiment, the agent generation system 102 provides, through the agent generator interface 108, a save option 116 that may be selected to save and implement the automated agent 112 according to the agent definition provided through the agent definition window 110. If the user 114 selects the save option 116 from the agent generator interface 108, the agent generation system 102 may dynamically store the programmatic code corresponding to the agent definition provided through the agent definition window 110, as well as the graphical representation of the agent definition generated through the agent definition window 110, within the models repository 106. This programmatic code and graphical representation of the agent definition may be associated, within the models repository 106, with an entry corresponding to the automated agent 112. This entry may be associated with a unique identifier selected by the user 114 or automatically automated by the agent generation system 102. The user 114, when accessing the agent generator interface 108, may provide this unique identifier, which may be used by the agent generation system 102 to retrieve the programmatic code and graphical representation of the agent definition from the models repository 106. The agent generation system 102 may use the retrieved programmatic code and graphical representation to update the agent definition window 110 and present the graphical representation of the functions and processes associated with the automated agent 112. As described in greater detail herein, the programmatic code corresponding to the agent definition may be converted into a configuration file that may be implemented through a runtime environment. This configuration file may be stored within the models repository 106 to enable the user 114 to access the programmatic code and make any modifications to the agent definition as needed. Further, through the models repository 106, the configuration file associated with the automated agent 112 may be made available to other users, which may use the configuration file to implement the automated agent 112 as a function or process that is to be invoked by a different automated agent.

In addition to the save option 116, the agent generation system 102 may provide, through the agent generator interface 108, a test option 118 that may be selected to perform an evaluation of the automated agent 112 and readily review any intermediate functions or processes executed by the automated agent 112. For example, if the user 114 selects the test option 118, the agent generation system 102, through the agent evaluation module 104, may dynamically update the agent generator interface 108 to provide a simulation of the automated agent 112. This simulation of the automated agent 112, in some instances, may include a user input field through which the user 114 may submit a user prompt to the automated agent 112 to obtain an output.

When the user 114 submits a user prompt through the user input field provided through the agent generator interface 108, the agent generation system 102 may process this user prompt according to the agent definition generated through the agent definition window 110 to generate an output. In an embodiment, the agent generation system 102, in response to the user prompt, further updates the agent generator interface 108 to present the submitted user prompt and the output generated through the simulation of the automated agent 112. This may allow the user 114 to determine whether the automated agent 112 has generated an expected output and/or identify any inaccuracies or other errors in the provided output. Based on this evaluation, the user 114 may interact with the agent generator interface 108 to return to the agent definition window 110 and modify any of the functions or processes previously defined for the automated agent 112.

In an embodiment, in addition to providing the user prompt and corresponding output through the agent generator interface 108, the agent generation system 102 provides user interface elements corresponding to the intermediate functions and/or processes executed by the automated agent 112 to generate the presented output. For example, the agent generation system 102 may update the agent generator interface 108 to provide an option corresponding to each function or process executed by the automated agent 112 and that may be selected to review the operations performed by the LLM or other generative artificial intelligence process to generate an intermediate output. In an embodiment, when the user 114 selects a particular option to review a particular function or process performed by a particular LLM or other generative artificial intelligence process associated with the automated agent 112, the agent generation system 102 dynamically updates the agent generator interface 108 to present the programmatic code corresponding to the input provided to the LLM or other generative artificial intelligence process and the programmatic code corresponding to the output generated by the LLM or other generative artificial intelligence process based on the provided input. This may allow the user 114 to review each of the intermediate functions or processes executed by the automated agent 112 and identify any possible issues that may be rectified through the agent definition window 110.

In some instances, if the agent generation system 102, through the agent evaluation module 104, detects any errors or other issues associated with the execution of the automated agent 112 through the presented simulation of the automated agent 112, the agent generation system 102 may dynamically update the agent generator interface 108 to present these errors or other issues. For instance, the agent generation system 102 may update the presented programmatic code corresponding to a function or process to graphically present the error or other issue in a manner that may be easily understood by the user 114. Similar to the presentation of errors through the agent definition window 110 described above, a portion of the programmatic code associated with the identified error may be highlighted or otherwise distinguished from the other portions of the programmatic code to graphically illustrate the identified error. In some instances, the agent evaluation module 104 may additionally, or alternatively, change the font and/or font style of the programmatic code associated with the identified error. For example, the agent evaluation module 104 may change the color of the font associated with the portion of the programmatic code associated with the identified error. Additionally, or alternatively, the agent evaluation module 104 may italicize, underline, make bold, or otherwise emphasize the portion of the programmatic code associated with the identified error. The agent generation system 102 may further indicate the cause of the error and possible solutions for addressing the identified error.

In an embodiment, the agent generation system 102, through the agent generator interface 108, allows the user 114 to dynamically modify the programmatic code corresponding to an intermediate function or process performed by the automated agent 112. If the user 114, through the agent generator interface 108, updates the programmatic code corresponding to an intermediate function or process associated with the simulation of the automated agent 112, the agent generation system 102, through the agent evaluation module 104, may dynamically process the previously submitted user prompt through the updated simulation of the automated agent 112 to generate new outputs (e.g., any intermediate outputs and a final output). Further, the agent evaluation module 104 of the agent generation system 102 may automatically evaluate the updated programmatic code associated with the intermediate function or process to determine whether there are any errors or other issues that need to be addressed prior to the automated agent 112 being implemented. Any detected errors or issues may be presented through the agent generator interface 108 through any of the error presentation mechanisms described above.

In an embodiment, if the user 114 makes a modification to the programmatic code of an intermediate function or process during the simulation of the automated agent 112, the agent generation system 102 may dynamically update the graphical representation of the functions or processes of the automated agent 112 to incorporate this modification. For example, if the user 114 modifies the programmatic code of an intermediate function or process during the simulation of the automated agent 112 to cause the output of the intermediate function or process to be transmitted to a different LLM or other generative artificial intelligence process, the agent generation system 102 may dynamically update the graphical representation of the functions or processes of the automated agent 112 to graphically represent a new connection between a node corresponding to the intermediate function or process to the node corresponding to the different LLM or other generative artificial intelligence process. When the user 114 exits the simulation of the automated agent 112 (such as through selection of an option presented through the agent generator interface 108 for returning to the graphical representation of the automated agent 112), the agent generation system 102 may dynamically update the agent generator interface 108 to present, through the agent definition window 110, an updated graphical representation of the functions and processes of the automated agent 112 and that corresponds to the modifications made by the user 114 to the programmatic code.

In an embodiment, if the user 114 is satisfied with the configuration of the automated agent 112 (as defined through the agent definition window 110), the agent generation system 102 can process the various functions and processes associated with the automated agent 112 (including the different LLMs and/or other generative artificial intelligence processes configured to execute these functions and processes) through a runtime environment (RTE) in a just-in-time (JIT) manner to enable users (including user 114) to invoke the automated agent. For instance, the agent generation system 102 may generate a configuration file that incorporates the defined functions and processes associated with the automated agent 112 that is provided to the RTE. The RTE, in response to obtaining this configuration file, may expose an API endpoint corresponding to the configuration file and that may be made available to the user 114 through a POST API call to the API endpoint. Through the API endpoint, an end user may access the automated agent 112 to submit new prompts and obtain corresponding outputs. Thus, when a user invokes an API call to the API endpoint associated with the automated agent 112, the automated agent 112 can take on the user prompts and return responses based on the functions and processes being executed by the different LLMs and/or other generative artificial intelligence processes leveraged by the automated agent 112.

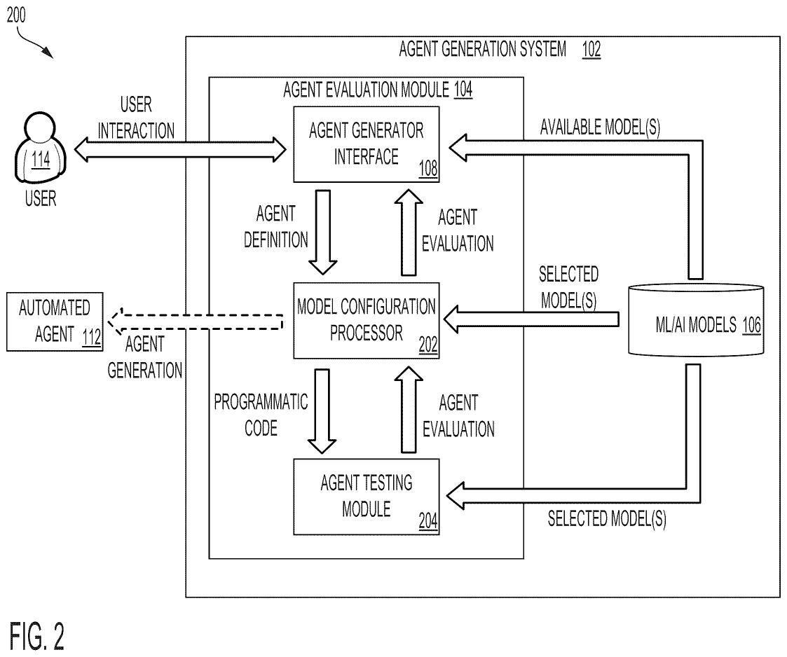

FIG. 2 shows an illustrative example of an environment 200 in which an agent generation system 102, through an agent evaluation module 104, processes user interactions with an agent generator interface 108 to evaluate and generate an automated agent 112 in accordance with at least one embodiment. In the environment 200, the agent evaluation module 104 implemented by the agent generation system 102 includes an agent generator interface 108 through which a user 114 may define the different functions and/or processes that are to be performed by an automated agent 112. When a user 114 accesses the agent generator interface 108 to generate an automated agent 112 according to different functions and/or processes that are to be executed, the agent generator interface 108 may access a models repository 106 to identify different pre-trained LLMs and/or other generative artificial intelligence processes and other available automated agents that may be available for performance of different functions and/or processes associated with an automated agent 112. As noted above, these pre-trained LLMs or other generative artificial intelligence processes may be obtained from external and/or internal sources. For instance, the pre-trained LLMs or other generative artificial intelligence processes may include one or more open source LLMs or other generative artificial intelligence processes, one or more proprietary LLMs or other generative artificial intelligence processes, and the like.

In an embodiment, the agent generation system 102 identifies which pre-trained LLMs and/or other generative artificial intelligence processes and other automated agents are available to the user 114 for generation of automated agents 112 according to any applicable authorization policies or rules. For example, a user 114 may not be authorized to utilize certain proprietary pre-trained LLMs and/or other generative artificial intelligence processes for which the user 114 does not maintain applicable licenses. In some instances, a user 114 may be subject to authorization policies or rules based on their location or on the locations in which the automated agent 112 is to be implemented. These authorization policies or rules may include export control policies or rules that may define the geographic locations where certain LLMs and/or other generative artificial intelligence processes may be implemented. Based on these authorization policies or rules, the agent generator interface 108 may dynamically identify and present the pre-trained LLMs and/or other generative artificial intelligence processes that are available to the user 114.

As noted above, the agent generator interface 108 provides the user 114 with different graphical elements that may be manipulated through the agent generator interface 108 to define an automated agent 112. For example, the agent generator interface 108 may allow the user 114 to add, delete, modify, or otherwise manipulate different nodes to define the functions and processes that are to be executed by the automated agent 112 in response to user requests or prompts. Additionally, through the agent generator interface 108, the user 114 may connect these different nodes to indicate the processing paths for the automated agent 112. For instance, a connection between a first node and a second node defined through the agent generator interface 108 may denote that the output of a function or process associated with the first node is to be used as input to the functionality or process associated with the second node. The agent generator interface 108 further provides a set of options for introducing different nodes that may be used to define the different functions and processes associated with the automated agent 112. For example, the agent generator interface 108 may provide the user 114 with options to introduce a node corresponding to a particular LLM or other generative artificial intelligence process, a node corresponding to an API through which a LLM or other generative artificial intelligence process may communicate with other systems, a node corresponding to a database through which a LLM or other generative artificial intelligence may automatically process a provided input to generate an output, and the like.

If the agent evaluation module 104, through the agent generator interface 108, detects user creation of a new node corresponding to a new function or process that is to be performed by the automated agent 112, the agent generator interface 108 may be dynamically updated to present, through a configuration window corresponding to the new node, a set of options for defining this new function or process. Through this configuration window within the agent generator interface 108, the agent evaluation module 104 may provide the user 114 with options for selecting the LLM or other generative artificial intelligence process that is to execute the particular function or process. As noted above, the LLMs and/or other generative artificial intelligence processes available to the user 114 may be selected according to any applicable authorization policies or rules. Thus, these options may correspond to the LLMs and/or other generative artificial intelligence processes that the user 114 is authorized to access and use for generation of automated agents.

As noted above, through the agent generator interface 108, the user 114 may be provided with an option to define a prompt that is to be processed by a selected LLM or other generative artificial intelligence process according to a defined function or process to generate a desired output. This prompt may differ from the prompt that is to be processed by the automated agent 112. Returning to an earlier illustrative example, the prompt provided through the agent generator interface 108 and corresponding to a particular node may define the function or process that the corresponding LLM or other generative artificial intelligence process is to perform in response to a user request (e.g., a user prompt) made to the automated agent. This prompt may thus instruct the selected LLM or other generative artificial intelligence process how to process a received user prompt. Further, this prompt may not be visible or otherwise accessible to an end user interacting with the automated agent 112.

In an embodiment, the agent generator interface 108 further provides the user 114 with an option to review the programmatic code associated with the particular node. For instance, as the user 114, through the agent generator interface 108, configures a particular node corresponding to a particular function or process to be executed by a selected LLM or other generative artificial intelligence process, a model configuration processor 202 implemented by the agent evaluation module 104 may dynamically process this configuration to generate programmatic code corresponding to the particular function or process. For instance, the model configuration processor 202 may identify the LLM or other generative artificial intelligence process selected by the user 114 and may access the models repository 106 to identify any programmatic code requirements for the LLM or other generative artificial intelligence process (e.g., programming languages, required input and/or output formats, etc.). If the user, through the agent generator interface 108, selects an option to review the programmatic code associated with a particular function or process, the agent generator interface 108 may automatically obtain the programmatic code associated with the function or process from the model configuration processor 202 and present this programmatic code to the user 114 for review.

In an embodiment, when the user 114 defines a new node corresponding to a new function or process, the model configuration processor 202 transmits the programmatic code corresponding to this new function or process to an agent testing module 204 implemented by the agent evaluation module 104 for evaluation. The agent testing module 204, in response to receiving the programmatic code corresponding to a new node, automatically evaluates the programmatic code to determine whether there are any errors or other issues that need to be addressed prior to the automated agent 112 being implemented. For instance, the agent testing module 204, based on the LLM or other generative artificial intelligence process selected for execution of the defined function or process, may access the models repository 106 to identify any programmatic code requirements for the LLM or other generative artificial intelligence process. Based on these requirements, the agent testing module 204 may automatically evaluate the programmatic code to determine whether the programmatic code includes (or otherwise results in) any syntax errors, semantic errors, logic errors, compilation errors, runtime errors, interface errors, and the like.

If the agent testing module 204 detects any errors or other issues associated with the programmatic code associated with the particular node, the agent testing module 204 may dynamically update the agent generator interface 108 to present the detected errors or other issues. Returning to an earlier illustrative example, if the agent testing module 204 detects an error associated with the programmatic code corresponding to a particular node, the agent testing module 204 may update the agent generator interface 108 to present the programmatic code and the location of the identified error. The identified error may be graphically represented in a manner that may be easily understood by the user 114. For example, the portion of the programmatic code associated with the identified error may be highlighted or otherwise distinguished from the other portions of the programmatic code to graphically illustrate the identified error. In some instances, the agent testing module 204 may additionally, or alternatively, change the font and/or font style of the programmatic code associated with the identified error. In some instances, in addition to illustrating any detected errors through the agent generator interface 108, the agent testing module 204 may further indicate the cause of the error and possible solutions for addressing the identified error.

The user 114, through the agent generator interface 108, can dynamically modify the programmatic code associated with a particular node. As the user 114 dynamically makes these modifications to the programmatic code, the agent testing module 204, in an embodiment, dynamically evaluates these modifications to determine whether any previously indicated errors have been addressed and whether there are any new errors that may impact performance of the automated agent 112. Based on this evaluation, the agent testing module 204 may dynamically update the agent generator interface 108 to remove any prior error indications (if the errors have been resolved) and/or present any newly detected errors.

The agent generator interface 108 may further provide the user 114 with one or more options for routing the outputs of the function or process associated with the new node to these other nodes. Returning to an earlier illustrative example, the agent evaluation module 104, through the agent generator interface 108, may automatically identify the other nodes associated with the automated agent 112 and present options corresponding to these other nodes for routing of the outputs from the new node. In an embodiment, if the user 114 defines, through selection of an option corresponding to another node, a routing path for an output of the new node, the agent generator interface 108 may be automatically updated to present a connector between the new node and the other node selected by the user 114. This connector may graphically represent a connection between these nodes and may denote a processing path whereby the output of the new node is used as input to the LLM or other generative artificial process associated with the other node. This may allow the user 114 to visually review the processing paths of the automated agent 112 as different LLMs or other generative artificial intelligence processes associated with the automated agent 112 execute their corresponding functions or processes.

As noted above, the agent generator interface 108 may provide an option to simulate the operation of the automated agent 112. If the user 114 selects this provided option, the agent testing module 204 may dynamically update the agent generator interface 108 to provide a simulation of the automated agent 112. This simulation of the automated agent 112, in some instances, may include a user input field through which the user 114 may submit a user prompt to the automated agent 112 to obtain an output. When the user 114 submits a user prompt through the user input field provided through the agent generator interface 108, the agent testing module 204 may process this user prompt according to the agent definition generated through the agent generator interface 108 to generate an output. In an embodiment, the agent testing module 204, in response to the user prompt, further updates the agent generator interface 108 to present the submitted user prompt and the output generated through the simulation of the automated agent 112.

In addition to providing the user prompt and corresponding output through the agent generator interface 108, the agent testing module 204, through the agent generator interface 108, provides options corresponding to each function or process executed by the automated agent 112 and that may be selected to review the operations performed by the LLM or other generative artificial intelligence process to generate an intermediate output. In an embodiment, when the user 114 selects a particular option to review a particular function or process performed by a particular LLM or other generative artificial intelligence process associated with the automated agent 112, the agent testing module 204 dynamically updates the agent generator interface 108 to present the programmatic code corresponding to the input provided to the LLM or other generative artificial intelligence process and the programmatic code corresponding to the output generated by the LLM or other generative artificial intelligence process based on the provided input.

In addition to providing the programmatic code corresponding to the input provided to the LLM or other generative artificial intelligence process, the agent testing module 204 may indicate, through the agent generator interface 108, any errors or other issues associated with the programmatic code. For instance, the agent testing module 204 may update the presented programmatic code corresponding to the intermediate function or process being evaluated to graphically present the error or other issue in a manner that may be easily understood by the user 114. Similar to the presentation of errors associated with the graphical representation of the automated agent 112 described above, a portion of the programmatic code associated with the identified error may be highlighted or otherwise distinguished from the other portions of the programmatic code to graphically illustrate the identified error. In some instances, the agent testing module 204 may additionally, or alternatively, change the font and/or font style of the programmatic code associated with the identified error. The agent generation system 102 may further indicate the cause of the error and possible solutions for addressing the identified error.

The agent testing module 204, during the simulation of the automated agent 112 and through the agent generator interface 108, may further allow the user 114 to dynamically modify the programmatic code corresponding to the selected intermediate function or process. If the user 114, through the agent generator interface 108, updates the programmatic code corresponding to an intermediate function or process associated with the simulation of the automated agent 112, the agent testing module 204 may dynamically process the previously submitted user prompt through the updated simulation of the automated agent 112 to generate new outputs (e.g., any intermediate outputs and a final output). Further, the agent testing module 204 may automatically evaluate the updated programmatic code associated with the intermediate function or process to determine whether there are any errors or other issues that need to be addressed prior to the automated agent 112 being implemented. Any detected errors or issues may be presented through the agent generator interface 108 through any of the error presentation mechanisms described above. Any modifications made to the programmatic code of an intermediate function or process during the simulation of the automated agent 112 may be dynamically processed to update the graphical representation of the functions or processes of the automated agent 112 according to the modification. This modification may be reflected through one or more graphical updates to the nodes and the corresponding connections impacted by the modification.

If the user 114 submits a request to implement the automated agent 112 graphically represented through the agent generator interface 108, the model configuration processor 202 may transform the various functions and processes associated with the automated agent 112 (including the different LLMs and/or other generative artificial intelligence processes configured to execute these functions and processes) into a configuration file. The model configuration processor 202, in an embodiment, provides the configuration file to an RTE implemented by the agent generation system 102, which may expose an API endpoint corresponding to the configuration file and that may accessed by users through a POST API call to the API endpoint. As noted above, through the API endpoint, a user may transmit a POST API call to the API endpoint to invoke the automated agent 112 and accordingly submit user prompts to the automated agent 112. Through the API endpoint, the automated agent 112 may further return responses to these user prompts based on the functions and processes being executed by the different LLMs and/or other generative artificial intelligence processes being leveraged by the automated agent 112.

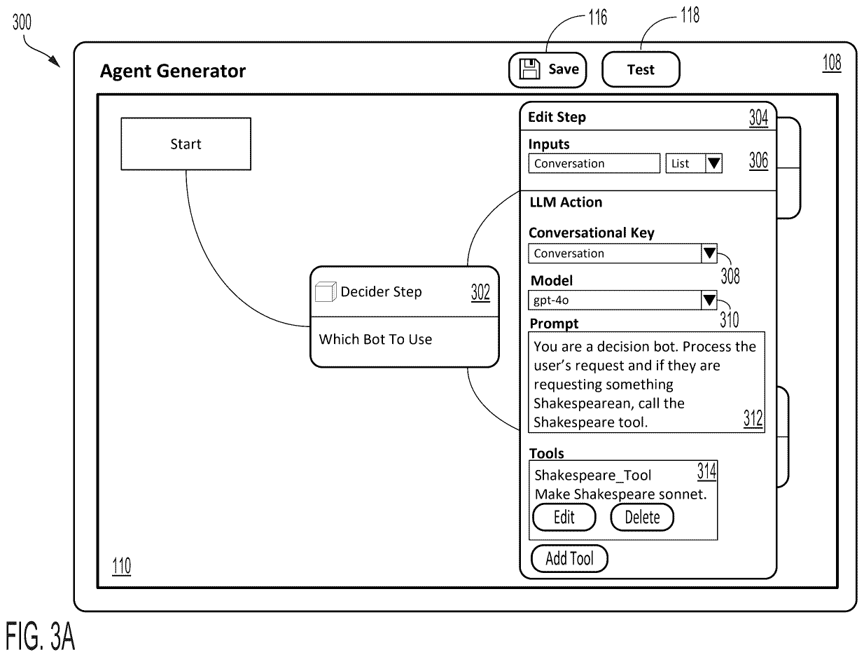

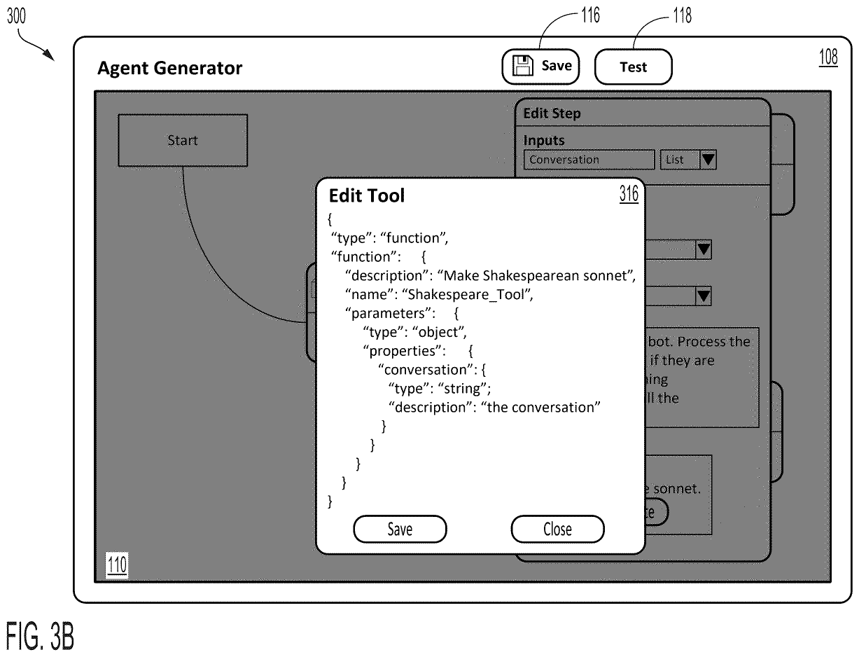

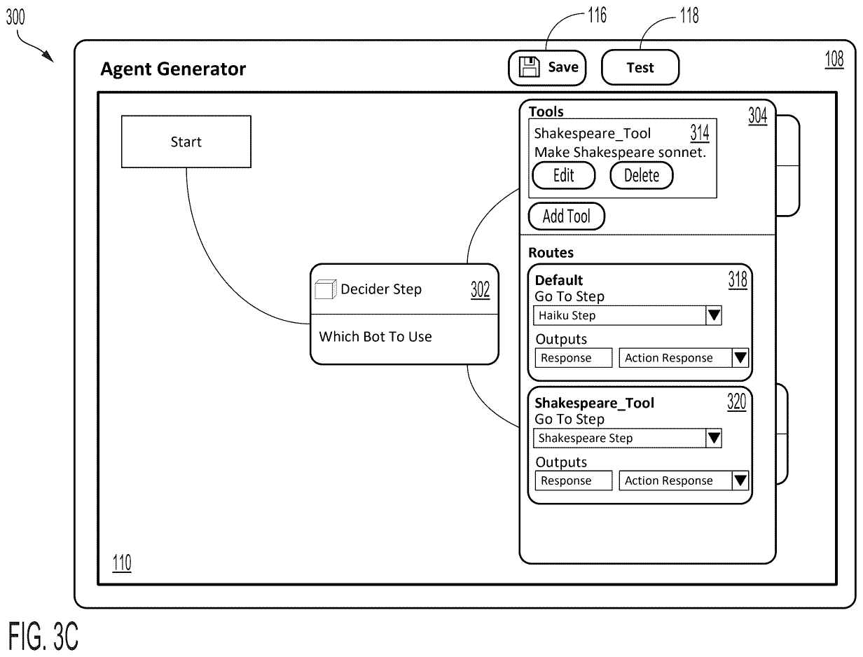

FIGS. 3A-3C show an illustrative example of an environment 300 in which different automated agent functions and processes are defined through an agent generator interface 108 in accordance with at least one embodiment. As illustrated in FIG. 3A, the agent generator interface 108 includes an agent definition window 110 through which a user 114 may generate and graphically manipulate different nodes (such as node 302) to define the functions and processes of an automated agent. Further, as noted above, the agent generator interface 108 may include a save option 116, that may be selected to save and implement the automated agent according to the agent definition provided through the agent definition window 110, and a test option 118, that may be selected to perform an evaluation of the automated agent and readily review any intermediate functions or processes executed by the automated agent.

As noted above, if the user generates, through the agent generator interface 108, a new node 302 corresponding to a new function or process that is to be performed by the automated agent, the agent generator interface 108 may be dynamically updated to present a configuration window 304 corresponding to the new node 302. Through this configuration window 304, the user may be presented with different options for defining this new function or process associated with the automated agent. For instance, as illustrated in FIG. 3A, the configuration window 304 may include a set of input options 306 through which the user may define the one or more types of inputs that may be processed by the LLM or other generative artificial intelligence process associated with the new node 302.

The configuration window 304 may further include a conversational key pull down menu 308, through which the user may define, for the particular LLM or other generative artificial intelligence process associated with the new node 302, a particular conversational key for the function or process that is to be executed by the LLM or other generative artificial intelligence process. Additionally, the configuration window 304 may include a model selection pull down menu 310, through which the user may select the particular LLM or other generative artificial intelligence process that is to be leveraged for execution of the function or process associated with the new node 302. As noted above, the agent generation system may identify which pre-trained LLMs and/or other generative artificial intelligence processes are available to a user according to any applicable authorization policies or rules. In some instances, a user may be subject to authorization policies or rules based on their location or on the locations in which the automated agent is to be implemented. Based on these authorization policies or rules, the agent generation system may dynamically identify and present, through the model selection pull down menu 310, the pre-trained LLMs and/or other generative artificial intelligence processes that are available to the user.

In an embodiment, the configuration window 304 provides a prompt input field 312, through which a user may define a prompt corresponding to the function or process that is to be performed by the selected LLM or other generative artificial intelligence process. Through the prompt input field 312, the user may provide a natural language request that includes one or more actions that are to be taken by the LLM or other generative artificial intelligence process to generate a desired output. For instance, as illustrated in FIG. 3A, the user has indicated that the selected LLM or other generative artificial intelligence process is a decision bot that is to process a user's request (e.g., an end user's prompt) and call a Shakespeare tool if the user's request is related to something Shakespearean. This prompt, when processed by the LLM or other generative artificial intelligence process, may instruct the LLM or other generative artificial intelligence process to process the user's request, determine whether the user's request is related to Shakespeare, and invoke a Shakespeare tool if the user's request is related to Shakespeare.

In some instances, the agent generation system may further allow a user to modify any parameter associated with a selected LLM or other generative artificial intelligence process and through the configuration window 304. For example, in addition to providing a prompt input field 312 through which the user may define a prompt corresponding to the function or process to be performed by the selected LLM or other generative artificial intelligence process, the agent generation system may provide one or more fields through which the user may define different inputs (e.g., temperature, biometric data, sensor data, etc.), structured outputs, and the like.

The configuration window 304 may further includes a tools window 314, through which a user can define the various tools that may be implemented by the selected LLM or other generative artificial intelligence process to dynamically process a received input in order to generate a desired output. Through the tools window 314, the user may be presented with an option to edit an existing tool, an option to delete an existing tool, and an option to add a new tool for the selected LLM or other generative artificial intelligence. In an embodiment, if the user selects the option to edit an existing tool, the agent generation system 102 dynamically updates the agent generator interface 108 to present the programmatic code associated with this tool.

As illustrated in FIG. 3B, selection of the aforementioned option may cause the agent generation system to present an edit tool window 316, through which the programmatic code associated with the selected tool is dynamically presented. As noted above, as the user, through the agent definition window 110 and the configuration window 304 defines the function or process associated with a selected LLM or other generative artificial intelligence process, the agent generation system dynamically generates programmatic code that can be executed to process a provided input through the one or more tools associated with the selected LLM or other generative artificial intelligence process. When the user selects the aforementioned option to edit a particular tool associated with the selected LLM or other generative artificial intelligence process, the agent generation system presents, through the edit tool window 316, the programmatic code associated with the selected tool. Through the edit tool window 316, the user may review and (if needed) modify the programmatic code associated with the selected tool to define the function or process corresponding to this tool that is to be executed by the LLM or other generative artificial intelligence process.

As noted above, the agent generation system may automatically evaluate the programmatic code associated with the automated agent, as the automated agent is defined through the agent generator interface 108, to determine whether there are any errors or other issues that need to be addressed prior to the automated agent being generated and implemented. The agent generation system may automatically evaluate this programmatic code to determine whether the programmatic code includes (or otherwise results in) any syntax errors, semantic errors, logic errors, compilation errors, runtime errors, interface errors, and the like. If the agent generation system detects any errors or other issues associated with the programmatic code associated with a particular node (such as node 302), the agent generation system may dynamically update the agent definition window 110 to present the detected errors or other issues. For example, if the agent generation system detects an error associated with the programmatic code corresponding to the Shakespeare tool illustrated in FIG. 3A, the agent generation system may update the edit tool window 316 to present the programmatic code and the location of the identified error. The identified error may be graphically represented in a manner that may be easily understood by the user, such as through highlighting of the identified error within the programmatic code, changes to the font and/or font style of the programmatic code associated with the identified error, and the like. Through the edit tool window 316, the agent generation system may further indicate the cause of the detected error and possible solutions for addressing the identified error.

Through the edit tool window 316, the user may further modify the programmatic code associated with the selected tool to address any identified errors, modify the functionality of the tool, add new functionalities to the tool, and the like. As the user modifies the programmatic code through the edit tool window 316, the agent generation system may dynamically evaluate these modifications to determine whether any previously indicated errors have been addressed and whether there are any new errors that may impact performance of the automated agent. Based on this evaluation, the agent generation system may dynamically update the edit tool window 316 to remove any prior error indications (if there were prior error indications and if these errors have been resolved) and/or present any newly detected errors. Further, if the user makes any modifications to the programmatic code associated with the tool through the edit tool window 316, the agent generation system may dynamically evaluate these modifications to determine whether they impact any previously defined connections between the new node 302 and any other nodes graphically represented through the agent definition window 110 and corresponding to other functions and/or processes defined for the automated agent. Based on this evaluation, if the agent generation system determines that the modification to the programmatic code results in one or more changes to the connections between the new node 302 and other nodes graphically represented through the agent definition window 110, the agent generation system may dynamically update the graphical representation of these connections to illustrate these one or more changes. Thus, as the user modifies the programmatic code associated with a particular tool associated with a particular LLM or other generative artificial intelligence process, the user may be able to immediately view, through the agent definition window 110, the impact of these modifications on the functionality of the automated agent.

As illustrated in FIG. 3C, the configuration window 304 may further include one or more routing windows 318-320 through which the user may define how the output generated by the LLM or other generative artificial intelligence process is to be routed to other nodes associated with the automated agent. For example, the configuration window 304 may include a default routing window 318, through which the user may define a default routing path for outputs generated by the LLM or other generative artificial intelligence process associated with the new node 302. The default routing window 318 may include a drop down menu, through which the user may select another node presented through the agent definition window 110 and to which, by default, the output of the LLM or other generative artificial intelligence process is to be routed. Returning to the prompt provided through the prompt input field 312 (i.e., where a Shakespeare tool is to be called if a user request is related to Shakespeare), the default routing path for the provided prompt is automatically selected if the submitted user request is not related to Shakespeare. Thus, through the default routing window 318, the user may select a node or tool that is different from the previously defined Shakespeare tool. However, in some instances, if the user selects the Shakespeare tool as the default routing path for a user request that is not related to Shakespeare, the agent generation system may update the configuration window 304 to indicate a potential conflict between the prompt provided in the prompt input field 312 and the default routing path defined through the default routing window 318. In some instances, to avoid such potential conflicts, the agent generation system may evaluate the prompt provided in the prompt input field 312 and identify any routing paths that may not serve as the default routing paths for a user request. Thus, using the illustrative example provided in FIGS. 3A-3C, the pull down menu associated with the default routing window 318 may be implemented without an option for selecting the node corresponding to the Shakespeare tool.

The configuration window 304 may further include an additional routing window 320, through which the user may define a specific routing path for an output of the LLM or other generative artificial intelligence process that satisfies one or more specific criteria. Returning to the illustrative example provided in FIGS. 3A-3C, if an end user submits a request that is related to Shakespeare, the LLM or other generative artificial intelligence process may determine that the Shakespeare tool is to be invoked in order to process the user request and generate a sonnet in the style of Shakespeare. Accordingly, the LLM or other generative artificial intelligence may route the user request to the Shakespeare tool for creation of a new sonnet in accordance with the user request. This routing path may not be default path, as defined through the prompt provided in the prompt input field 312 and as denoted through identification of a specific routing path through the additional routing window 320. It should be noted that the additional routing window 320 may be optional, such that, in some instances, a user may configure a function or process whereby all user requests and corresponding outputs are routed along a singular routing path.

In an embodiment, as the user interacts with the configuration window 304 to define the function or process that is to be executed by the selected LLM or other generative artificial intelligence system associated with the new node 302, the agent generation system may dynamically update the agent definition window 110 to graphically illustrate any connections between the new node 302 and any other nodes associated with other functions or processes being executed by one or more other LLMs or other generative artificial intelligence processes associated with the automated agent. For example, as illustrated in FIG. 3C, when the user initially defines the routing paths for the user request received by the LLM or other generative artificial intelligence process associated with the new node 302 (such as through routing windows 318-320), the agent generation system may dynamically update the agent definition window 110 to connect the new node 302 to a node corresponding to a Haiku Step and to a node corresponding to the Shakespeare Step. The connections to these two nodes may correspond to the default routing path defined through default routing window 318 and the Shakespeare_Tool routing path defined through routing window 320. Thus, as the user interacts with the configuration window 304, selects various options associated with the LLM or generative artificial intelligence process associated with the new node 302, and/or modifies the programmatic code associated with the LLM or generative artificial intelligence process, the agent generation system may dynamically update the agent definition window 110 to graphically represent these interactions, selections, and modifications.

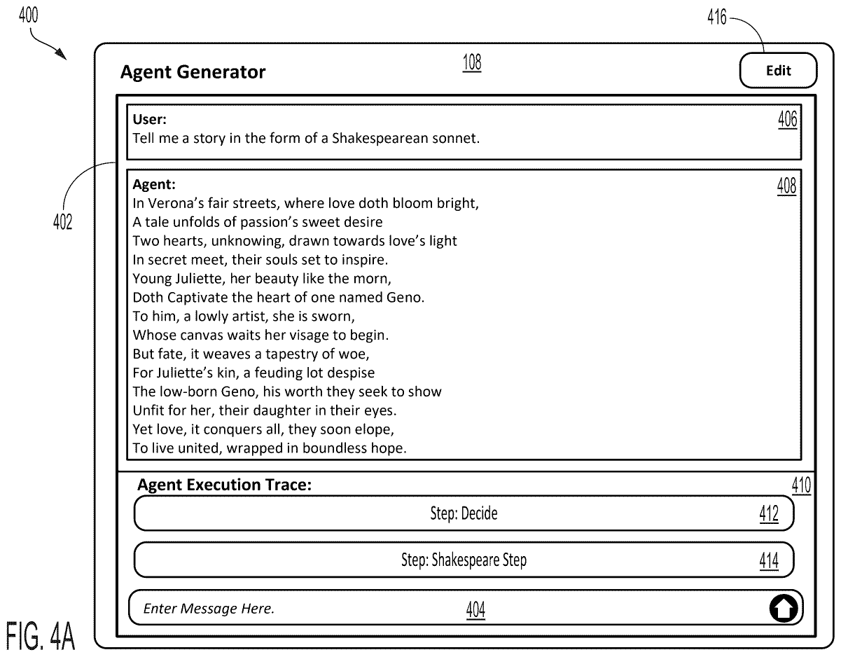

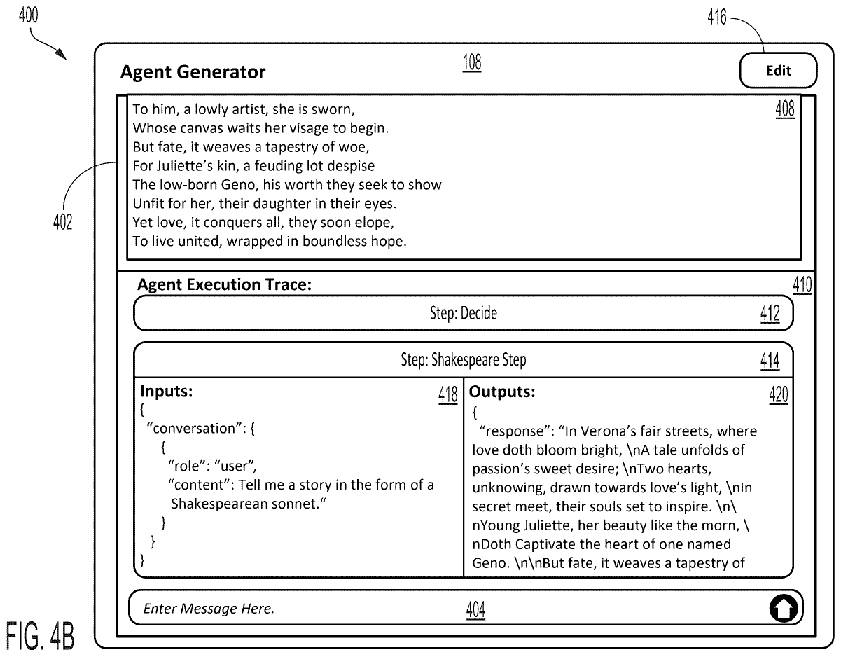

FIGS. 4A-4B show an illustrative example of an environment 400 in which different automated agent functions and processes are dynamically evaluated and tested in accordance with at least one embodiment. As illustrated in FIG. 4A, the agent generation system, through an agent generator interface 108, may provide a simulation of an automated agent, through which a user may submit user prompts to evaluate the performance of an automated agent defined through the agent generator interface 108. As noted above, through the agent generator interface 108, the agent generation system may provide a test option that, if selected, causes the agent generation system to dynamically update the agent generator interface 108 to provide a simulation of the automated agent.

As illustrated in FIG. 4A, the simulation of the automated agent provided through the agent generator interface 108 includes a user input field 404 through which the user may submit user prompts to the automated agent to obtain a desired output. In the illustrative example provided in FIGS. 4A-4B, the user has submitted the user prompt “Tell me a story in the form of a Shakespearean sonnet.” In response to user submission of this prompt through the user input field 404, the graphical representation of the simulation 402 may be dynamically updated to include the user prompt through a user prompt field 406. This may allow the user to review the user prompt that they have submitted to the automated agent for creation of an output.

In an embodiment, as the automated agent processes the provided user prompt through the different LLMs or other generative artificial intelligence processes, the automated agent may update the graphical representation of the simulation to provide, through an output field 408, any outputs generated by the automated agent. For example, as illustrated in FIG. 4A, in response to the user prompt indicating a request for a story in the form of a Shakespearean sonnet, the automated agent may provide, through the output field 408, an output that includes a Shakespearean sonnet. The user, through the output field 408, may review the output to evaluate the output generated by the automated agent. Based on this evaluation, the user may select an edit button 416 to cause the agent generation system to update the agent generator interface 108 and present the agent definition window. Through the agent definition window, the user may define and/or modify the different functions and processes associated with the automated agent.

In an embodiment, through the graphical representation of the simulation 402, the agent generation system further provides an agent execution trace window 410, through which the user can evaluate any of the intermediate functions or processes executed by the automated agent in generating the output provided in the output field 408. Through the agent execution trace window 410, the agent generation system may provide step evaluation buttons 412-414 that, when selected, may cause the agent generation system to update the agent generator interface 108 to present the inputs processed as part of the selected step and the outputs generated as a result of processing the inputs by the LLM or other generative artificial intelligence process associated with the selected step. As illustrated in FIG. 4A, the step evaluation buttons 412-414 correspond to the decision step taken by the automated agent and corresponding to node 302 illustrated in FIGS. 3A and 3C (e.g., the “Decider Step”) and to the Shakespeare Step taken by the automated agent as a result of the output of the decision step indicating that the user prompt corresponds to a request associated with Shakespeare. Thus, the step evaluation buttons 412-414 may correspond to the intermediate functions and/or processes executed by the automated agent to generate the output presented through the output field 408.

As illustrated in FIG. 4B, the user has selected the step evaluation button 414 corresponding to the Shakespeare Step. In response to user selection of this step evaluation button 414, the agent generation system may dynamically update the agent generator interface 108 to present an input programmatic code window 418 and an output programmatic code window 420. Through the input programmatic code window 418, the agent generation system may provide the programmatic code corresponding to the inputs provided to the LLM or other generative artificial intelligence process associated with the particular function or process (i.e., step). In some instances, the agent generation system may further provide the programmatic code corresponding to the LLM or other generative artificial intelligence process, which may provide an indication of how the input was processed by the LLM or other generative artificial intelligence process. The output programmatic code window 420 may include programmatic code corresponding to the outputs generated by the LLM or other generative artificial intelligence process associated with the particular function or process and according to the input provided in the input programmatic code window 418.

As noted above, in some instances, if the agent generation system detects any errors or other issues associated with the execution of the automated agent through the presented simulation of the automated agent, the agent generation system may dynamically update the agent generator interface 108 to present these errors or other issues. For instance, the agent generation system may update the input programmatic code window 418 and/or the output programmatic code window 420 to graphically present the error or other issue in a manner that may be easily understood by the user. Similar to the presentation of errors through the agent definition window described above, a portion of the programmatic code associated with the identified error and presented through either the input programmatic code window 418 or the output programmatic code window 420 may be highlighted or otherwise distinguished from the other portions of the programmatic code to graphically illustrate the identified error. In some instances, the agent generation system may additionally, or alternatively, change the font and/or font style of the programmatic code associated with the identified error. For example, the agent generation system may change the color of the font associated with the portion of the programmatic code associated with the identified error. Additionally, or alternatively, the agent generation system may italicize, underline, make bold, or otherwise emphasize the portion of the programmatic code associated with the identified error. The agent generation system may further indicate the cause of the error and possible solutions for addressing the identified error.

Through the input programmatic code window 418 and the output programmatic code window 420, the automated generation system may allow the user to dynamically modify the programmatic code corresponding to an intermediate function or process performed by the automated agent. If the user, through the input programmatic code window 418 and/or the output programmatic code window 420, updates the programmatic code corresponding to an intermediate function or process associated with the simulation of the automated agent, the agent generation system may dynamically process the previously submitted user prompt through the updated simulation of the automated agent to generate new outputs (e.g., any intermediate outputs and a final output). Further, the agent generation system may automatically evaluate the updated programmatic code associated with the intermediate function or process to determine whether there are any errors or other issues that need to be addressed prior to the automated agent being implemented. Any detected errors or issues may be presented through the input programmatic code window 418 and the output programmatic code window 420, as described above.

If the user makes a modification to the programmatic code of an intermediate function or process through the input programmatic code window 418 and/or the output programmatic code window 420, the agent generation system may dynamically update the graphical representation of the functions or processes associated with the automated agent to incorporate this modification. Returning to an earlier illustrative example, if the user, through the input programmatic code window 418 or the output programmatic code window 420, modifies the programmatic code of an intermediate function or process during the simulation of the automated agent to cause the output of the intermediate function or process to be transmitted to a different LLM or other generative artificial intelligence process, the agent generation system may dynamically update the graphical representation of the functions or processes associated with the automated agent to graphically represent a new connection between a node corresponding to the intermediate function or process to the node corresponding to the different LLM or other generative artificial intelligence process. When the user exits the simulation of the automated agent (such as through selection of the edit button 416), the agent generation system may dynamically update the agent generator interface 108 to present, through the agent definition window, an updated graphical representation of the functions and processes of the automated agent and that corresponds to the modifications made by the user to the programmatic code.

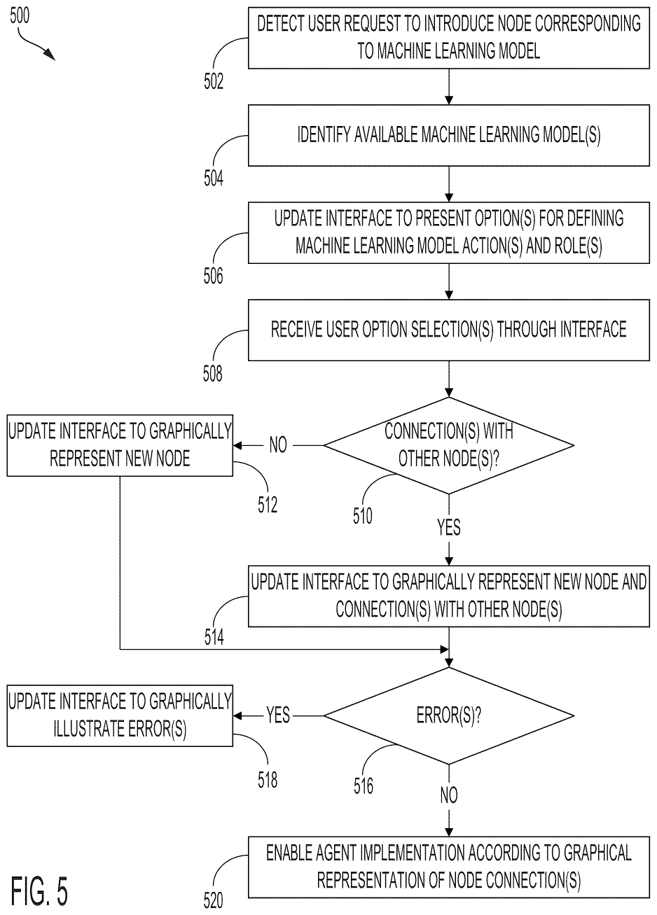

FIG. 5 shows an illustrative example of a process 500 for dynamically evaluating a graphical representation of a new automated agent according to connections among different nodes representing machine learning model elements in accordance with at least one embodiment. The process 500 may be performed by an agent evaluation module (such as agent evaluation module 104 illustrated in FIGS. 1-2) implemented by the agent generation system.

At step 502, the agent evaluation module may detect a user request to introduce a new node corresponding to a LLM or other generative artificial intelligence process that is to perform a particular function or process as part of an automated agent. For instance, through an agent generator interface, a user may select an option to introduce a new node to a graphical representation of the functions and processes associated with an automated agent. This may include introducing and manipulating an icon or other graphical element corresponding to a new function or process through an agent definition window of the agent generator interface. In some instances, the user may be another automated agent that may assist other users in generating new automated agents. If the user is another automated agent, the user request may be programmatic rather than through an agent generator interface. However, as the agent evaluation module processes a programmatic user request, the agent evaluation module may dynamically update the agent generator interface to provide a graphical representation of the user request, such as through introduction of a new node corresponding to the user request.

At step 504, in response to the user introduction of a new node corresponding to a new function or process that is to be performed by a LLM or other generative artificial intelligence process, the agent evaluation module may identify the available LLMs or other generative artificial intelligence processes that may be available to the user for performance of the new function or process. As noted above, the agent evaluation module may identify which pre-trained LLMs and/or other generative artificial intelligence processes are available to the user for generation of automated agents according to any applicable authorization policies or rules. Returning to an earlier illustrative example, a user may not be authorized to utilize certain proprietary pre-trained LLMs and/or other generative artificial intelligence processes for which the user does not maintain applicable licenses. In some instances, a user may be subject to authorization policies or rules based on their location or on the locations in which the automated agent is to be implemented. These authorization policies or rules may include export control policies or rules that may define the geographic locations where certain LLMs and/or other generative artificial intelligence processes may be implemented. Based on these authorization policies or rules, the agent evaluation module may dynamically identify the pre-trained LLMs and/or other generative artificial intelligence processes that are available to the user.

At step 506, the agent evaluation module may dynamically update the agent generator interface to present a set of options for defining the actions, functions, and processes that are to be performed by the LLM or other generative artificial intelligence process, as well as the roles of the LLM or other generative artificial intelligence process in the overall functionality of the automated agent. For instance, through a node configuration window (such as the configuration window 304 described above in connection with FIGS. 3A-3C), the agent evaluation module may present to the user a set of options for configuring the LLM or other generative artificial intelligence process. Through this configuration window, the agent evaluation module may provide the user with options for selecting any of the previously identified LLMs or other generative artificial intelligence processes that are available to the user and that can be implemented for performance of the particular function or process. The agent evaluation module may further provide the user with an option to define a prompt that is to be processed by the selected LLM or other generative artificial intelligence process to generate a desired output. This prompt may define the function or process that the selected LLM or other generative artificial intelligence process is to perform in response to a user request (e.g., a user prompt) made to the automated agent. The agent evaluation module may further provide the user with an option to review the programmatic code associated with the selected LLM or other generative artificial intelligence process. Additionally, the agent evaluation module may provide the user with one or more options for defining the routing paths for the output of the LLM or other generative artificial intelligence process, including a default routing path and other routing paths that may be selected according to the characteristics of the user prompt being processed by the LLM or other generative artificial intelligence process.

At step 508, the agent evaluation module receives different user option selections through the agent generator interface for the new node. These selections may include a selection of a particular LLM or other generative artificial intelligence process that is to execute a particular function or process, a definition of the function or process that is to be executed, any routing paths that are to be determined based on a user prompt and/or output of the LLM or other generative artificial intelligence process, and the like.

At step 510, the agent evaluation module evaluates the received user option selections for the new function or process to determine whether these selections define one or more new connections to other nodes associated with the automated agent. As noted above, the user may define, through the configuration window associated with the new node, one or more routing paths for outputs generated by the selected LLM or other generative artificial intelligence process. If the user has defined one or more routing paths for these outputs, the agent evaluation module may determine that there are connections between this new node and other nodes associated with the automated agent. Accordingly, at step 514, the agent evaluation module may dynamically update the agent generator interface to graphically represent the new node and these connections between the new node and the other nodes corresponding to the selected routing paths indicated through the configuration window. Otherwise, if no routing paths have been defined or the user has otherwise not indicated any connections between the new node and other nodes associated with the automated agent, the agent evaluation module, at step 512, may update the agent generator interface to graphically represent the new node. This new node may be presented without any connections to other nodes associated with the automated agent.

At step 516, the agent evaluation module may evaluate the new node to determine whether there are any errors that need to be addressed. As noted above, when the user, through the configuration window, defines the function or process that is to be performed by the selected LLM or other generative artificial intelligence process, the agent evaluation module may identify any programmatic code requirements for the LLM or other generative artificial intelligence process. Based on these requirements, the agent evaluation module may automatically evaluate the programmatic code to determine whether the programmatic code includes (or otherwise results in) any syntax errors, semantic errors, logic errors, compilation errors, runtime errors, interface errors, and the like.

If the agent evaluation module determines that the programmatic code associated with the newly defined function or other process includes one or more errors, the agent evaluation module, at step 518, may update the agent generator interface to graphically illustrate these one or more errors. For instance, if the agent evaluation module detects an error associated with the programmatic code corresponding to a particular node, the agent evaluation module may update the agent generator interface to present the programmatic code associated with the particular node and the location within the programmatic code of the identified error. The identified error may be graphically represented in a manner that may be easily understood by the user. For example, the portion of the programmatic code associated with the identified error may be highlighted or otherwise distinguished from the other portions of the programmatic code to graphically illustrate the identified error. In some instances, the agent evaluation module may additionally, or alternatively, change the font and/or font style of the programmatic code associated with the identified error. In some instances, in addition to illustrating any detected errors through the agent generator interface, the agent evaluation module may further indicate the cause of the error and possible solutions for addressing the identified error. By graphically illustrating the source of the detected error, the user, through the agent generator interface, can dynamically modify the programmatic code associated with a particular node. As the user dynamically makes these modifications to the programmatic code, the agent evaluation module dynamically evaluates these modifications to determine whether any previously indicated errors have been addressed and whether there are any new errors that may impact performance of the automated agent. Based on this evaluation, the agent evaluation module may dynamically update the agent generator interface to remove any prior error indications (if the errors have been resolved) and/or present any newly detected errors.

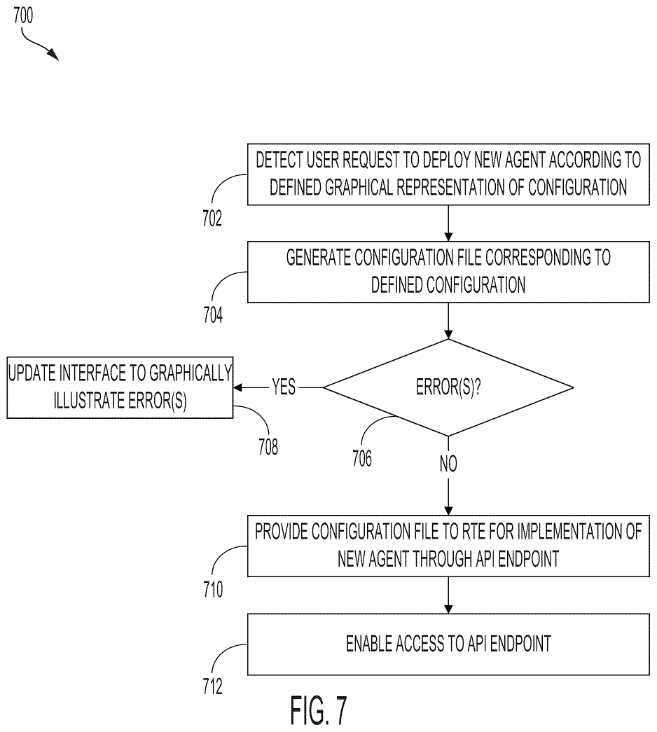

If the agent evaluation module determines that the new node is devoid of errors, the agent evaluation module, at step 520, may enable implementation of the automated agent according to the graphical representation of the various nodes defining the functions and processes to be performed by the automated agent and of the various connections amongst these nodes and that denote processing paths for the automated agent. For example, the agent evaluation module may implement a runtime environment through which the programmatic code associated with the automated agent is executed. For instance, through the runtime environment, the agent evaluation module may process the automated agent specification (as defined through the graphical representation of the various nodes and the connections amongst these nodes) in a just-in-time (JIT) manner to enable invocation of the automated agent by the user of the agent generation system. In some alternative examples, this may include providing the user with an option to compile the programmatic code associated with the automated agent to generate a microservice that may be implemented to allow user interaction with the automated agent. This process for generating enabling the implementation of the automated agent is described in greater detail herein in association with FIG. 7.

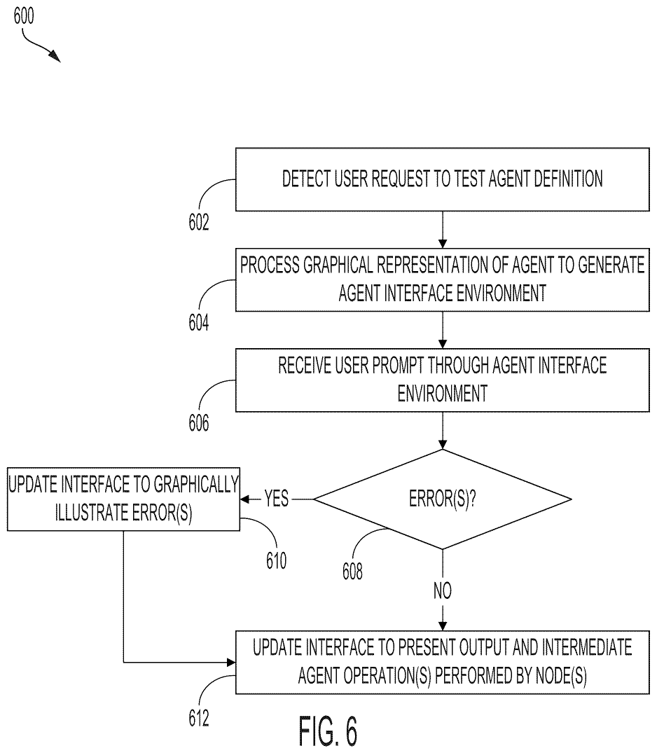

FIG. 6 shows an illustrative example of a process 600 for dynamically testing a performance of an automated agent and providing data corresponding to intermediate operations performed by the automated agent in accordance with at least one embodiment. The process 600 may be performed by an agent testing module implemented by the aforementioned agent evaluation module.

At step 602, the agent testing module may detect a request from a user to test an automated agent definition provided through an agent generator interface. As noted above, through the agent generator interface, a user may define a set of nodes corresponding to different functions and/or processes that are to be executed by an automated agent and through which the automated agent may process user prompts to generate desired outputs. In addition to defining this set of nodes, a user, through the agent generator interface, may define connections amongst these nodes to establish different routing paths for any intermediate outputs that may be processed by different LLMs and/or other generative artificial intelligence processes to generate other intermediate outputs and/or final outputs. In an embodiment, the agent generation system provides, through the agent generator interface, a test option that may be selected to perform an evaluation of the automated agent and readily review any of these intermediate functions or processes executed by the automated agent. Selection of this test option may denote the user request to test the automated agent definition.

At step 604, the agent testing module may process the graphical representation of the automated agent to generate an agent interface environment through which a simulation of the automated agent may be provided. For instance, the agent testing module may compile the programmatic code associated with the various functions and processes defined through the agent generator interface to create the simulation of the automated agent. Further, the agent testing module may dynamically update the agent generator interface to provide the simulation of the automated agent. This simulation of the automated agent may include a user input field through which a user may submit a sample user prompt to the automated agent to obtain an output. Thus, through the simulation of the automated agent, the user may evaluate the performance of the automated agent prior to deployment of the automated agent.

At step 606, through the user prompt field provided through the agent generator interface and associated with the simulation of the automated agent, the agent testing module may receive a user prompt. In response to this user prompt, the agent testing module may process the user prompt according to the different functions and processes of the automated agent to determine, at step 608, whether any errors were detected during the processing of the provided user prompt.

If the agent testing module detects any errors or other issues associated with the execution of the automated agent through the presented simulation of the automated agent, the agent testing module, at step 610, may dynamically update the agent generator interface to graphically present these errors or other issues. For instance, the agent testing module, through the agent generator interface, may update the programmatic code corresponding to a function or process associated with the detected error or other issue to graphically present the error or other issue in a manner that may be easily understood by the user. Similar to the presentation of errors through the agent definition window described above, a portion of the programmatic code associated with the identified error may be highlighted or otherwise distinguished from the other portions of the programmatic code to graphically illustrate the identified error. In some instances, the agent testing module may additionally, or alternatively, change the font and/or font style of the programmatic code associated with the identified error. For example, the agent testing module may change the color of the font associated with the portion of the programmatic code associated with the identified error. Additionally, or alternatively, the agent testing module may italicize, underline, make bold, or otherwise emphasize the portion of the programmatic code associated with the identified error. The agent testing module may further indicate the cause of the error and possible solutions for addressing the identified error.

In an embodiment, the agent testing module, through the agent generator interface, allows users to dynamically update the programmatic code corresponding to the intermediate functions and processes associated with the automated agent to address any identified errors or other issues. For instance, as noted above, if a user, through an input programmatic code window (such as the input programmatic code window 418 described above in connection with FIG. 4B) and/or an output programmatic code window (such as the output programmatic code window 420 described above in connection with FIG. 4B), updates the programmatic code corresponding to an intermediate function or process associated with the simulation of the automated agent, the agent testing module may dynamically process the previously submitted user prompt through the updated simulation of the automated agent to generate new outputs (e.g., any intermediate outputs and a final output). Further, the agent testing module may automatically evaluate the updated programmatic code associated with the intermediate function or process to determine whether there are any errors or other issues that need to be addressed prior to the automated agent being implemented. Any detected errors or issues may be presented through the agent generator interface, as described above.

At step 612, the agent testing module may update the agent generator interface to present the final output of the simulation of the automated agent and any intermediate outputs generated through the different functions and processes associated with the automated agent and as graphically depicted through different nodes. For instance, in response to the user prompt provided through the simulation of the automated agent, the agent testing module may update the agent generator interface to present the submitted user prompt and the output generated through the simulation of the automated agent. This may allow the user to determine whether the automated agent has generated an expected output and/or identify any inaccuracies or other errors in the provided output. Based on this evaluation, the user may interact with the agent generator interface to return to the agent definition window and modify any of the functions or processes previously defined for the automated agent.

In addition to providing the user prompt and corresponding output through the agent generator interface, the agent testing module may provide user interface elements corresponding to the intermediate functions and/or processes executed by the automated agent to generate the presented output. For instance, the agent testing module may update the agent generator interface to provide an option corresponding to each intermediate function or process executed by the automated agent and that may be selected to review the operations performed by the corresponding LLM or other generative artificial intelligence process to generate an intermediate output. When the user selects a particular option to review a particular function or process performed by a particular LLM or other generative artificial intelligence process associated with the automated agent, the agent testing module dynamically updates the agent generator interface to present the programmatic code corresponding to the input provided to the LLM or other generative artificial intelligence process and the programmatic code corresponding to the output generated by the LLM or other generative artificial intelligence process based on the provided input. This may allow the user to review each of the intermediate functions or processes executed by the automated agent and identify any possible issues that may be rectified through the agent definition window. Additionally, any errors detected by the agent testing module may be graphically presented to the user through the programmatic code, as described above.

As previously noted, the agent testing module may allow the user to dynamically modify the programmatic code corresponding to an intermediate function or process performed by the automated agent. If the user updates the programmatic code corresponding to an intermediate function or process associated with the simulation of the automated agent, the agent testing module may dynamically process the previously submitted user prompt through the updated simulation of the automated agent to generate new outputs (e.g., any intermediate outputs and a final output). Further, the agent testing module may automatically evaluate the updated programmatic code associated with the intermediate function or process to determine whether there are any errors or other issues that need to be addressed prior to the automated agent being implemented. Any detected errors or issues may be graphically presented to the user through the agent generator interface.

It should be noted that the process 600 may include additional and/or alternative steps not illustrated in FIG. 6. For example, if the user modifies the programmatic code of an intermediate function or process through the agent generator interface and during the simulation of the automated agent, the agent testing module may dynamically update the graphical representation of the functions or processes associated with the automated agent to incorporate this modification. Returning to an earlier illustrative example, if the user modifies the programmatic code of an intermediate function or process during the simulation of the automated agent to cause the output of the intermediate function or process to be transmitted to a different LLM or other generative artificial intelligence process, the agent testing module may dynamically update the graphical representation of the functions or processes associated with the automated agent to graphically represent a new connection between a node corresponding to the intermediate function or process to the node corresponding to the different LLM or other generative artificial intelligence process. When the user exits the simulation of the automated agent, the agent testing module may dynamically update the agent generator interface to present, through the agent definition window, an updated graphical representation of the functions and processes of the automated agent and that corresponds to the modifications made by the user to the programmatic code.

FIG. 7 shows an illustrative example of a process 700 for implementing a new automated agent based on a graphical representation of an automated agent configuration in accordance with at least one embodiment. The process 700 may be performed by a model configuration processor (such as the model configuration processor 202 described above in connection with FIG. 2) implemented by the agent evaluation module.

At step 702, the model configuration processor may detect a user request to deploy a new automated agent according to a graphical representation of the automated agent configuration provided through the agent generator interface. For instance, the agent generation system may provide, through the agent generator interface, one or more graphical elements (e.g., GUI buttons, etc.) that may be selected to indicate a request to deploy an automated agent according to the configuration graphically represented through the agent generator interface. If the user selects these one or more graphical elements, the model configuration processor may determine that the user wishes to deploy a new automated agent according to the defined configuration.

At step 704, the model configuration processor may generate a configuration file that incorporates the programmatic code corresponding to the different functions and/or processes defined for the automated agent through the agent generator interface. For instance, the model configuration processor may dynamically process the defined automated agent configuration to generate programmatic code corresponding to the different functions and/or processed. The model configuration processor may identify the LLMs and/or other generative artificial intelligence processes selected by the user and may access the models repository maintained by the agent generation system to identify the programmatic code requirements for these LLMs and/or other generative artificial intelligence processes (e.g., programming languages, required input and/or output formats, etc.). Based on these requirements and the configuration of the automated agent defined by the user through the agent generator interface, the model configuration processor may dynamically generate the programmatic code corresponding to the configuration. Using this programmatic code, the model configuration processor may generate a configuration file that incorporates the defined functions and processes associated with the automated agent.

At step 706, the model configuration processor may evaluate the configuration file to determine whether there are any errors that may prevent implementation of the automated agent. If the model configuration processor detects any errors associated with any of the functions and/or processes associated with the automated agent, the model configuration processor, at step 708, may update the agent generator interface to graphically illustrate these errors. For example, if the model configuration processor detects an error associated with the programmatic code corresponding to a particular function or process, the model configuration processor may update the agent generator interface to present the programmatic code associated with the particular function or process and the location within the programmatic code of the identified error. The identified error may be graphically represented in a manner that may be easily understood by the user, as described above.

If the model configuration processor determines that the configuration file associated with the automated agent is devoid of errors, the model configuration processor, at step 710, may provide the configuration file to an RTE implemented by the agent generation system to implement the new automated agent through an API endpoint. The model configuration processor, at step 712, may enable user access to this API endpoint to allow users to invoke the automated agent, submit prompts to the automated agent, and obtain responses to these prompts. For instance, the API endpoint may be accessed by users through an exposed POST API call to the API endpoint. Through endpoint API, an end user may access the automated agent to submit new prompts and obtain corresponding outputs. As noted above, the automated agent may process any prompts submitted through POST API calls to the API endpoint and based on the functions and processes being executed by the different LLMs and/or other generative artificial intelligence processes that are leveraged by the automated agent.

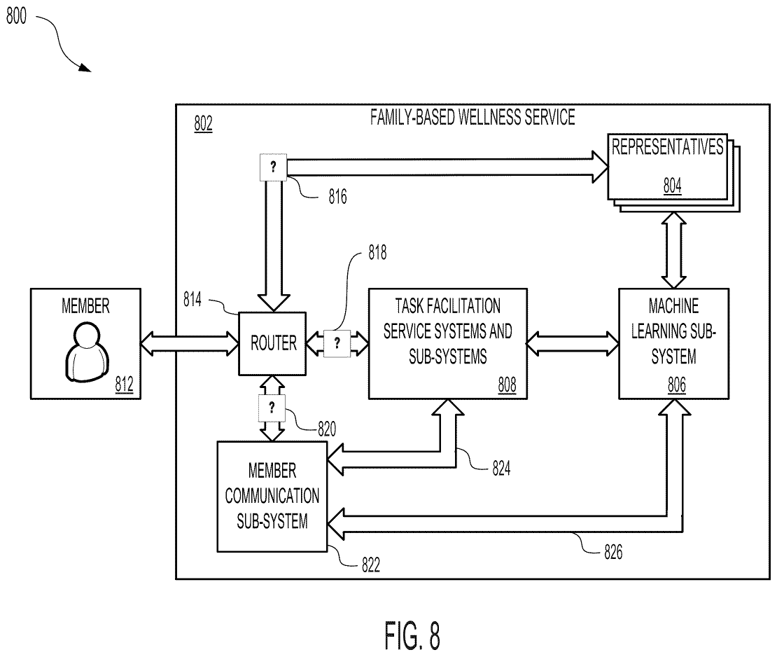

FIG. 8 shows an illustrative example of an environment 800 in which communications with members are processed in accordance with at least one embodiment. In an embodiment, operations performed by representatives 804 are partially and/or fully performed using one or more machine learning algorithms, artificial intelligence systems and/or computational models. For example, as the representatives 804 perform or otherwise coordinate performance of tasks on behalf of a member 812, the task facilitation service 802 may update a profile of the member 812 and/or a computational model of the profile of the member 812.

In an embodiment, as the representatives 804 perform or otherwise coordinate performance of tasks on behalf of a member 812, the task facilitation service 802 updates a profile of the member 812 and/or a computational model of the profile of the member 812 continuously. For example, as a member 812 communicates with a system of the task facilitation service 802, the task facilitation service 802 may update the profile of the member 812 and/or a computational model of the profile of the member 812 continuously during the course of the interaction.

In an embodiment, as the representatives 804 perform or otherwise coordinate performance of tasks on behalf of a member 812, the task facilitation service 802 updates a profile of the member 812 and/or a computational model of the profile of the member 812 dynamically. For example, as a task is performed on behalf of a member 812, a vendor performing the task may provide regular updates to the task facilitation service 802 and the task facilitation service 802 may update the profile of the member 812 and/or a computational model of the profile of the member 812 dynamically at each update from the vendor.

In an embodiment, as the representatives 804 perform or otherwise coordinate performance of tasks on behalf of a member 812, the task facilitation service 802 updates a profile of the member 812 and/or a computational model of the profile of the member 812 automatically. For example, when a proposal is generated for the member, the task facilitation service 802 may update the profile of the member 812 and/or a computational model of the profile of the member 812 automatically as part of the proposal generation process.

In an embodiment, as the representatives 804 perform or otherwise coordinate performance of tasks on behalf of a member 812, the task facilitation service 802 updates a profile of the member 812 and/or a computational model of the profile of the member 812 in real-time. For example, when a member 812 accepts a proposal, the task facilitation service 802 may update the profile of the member 812 and/or a computational model of the profile of the member 812 at the time that the proposal acceptance is provided, rather than delaying the update.

In an embodiment, the task facilitation service 802 updates a profile of the member 812 and/or a computational model of the profile of the member 812 using a machine learning sub-system 806 of the task facilitation service 802. In an embodiment, a machine learning sub-system 806 is a component of the task facilitation service 802 that is configured to implement machine learning algorithms, artificial intelligence systems, and/or computation models. In an example, a machine learning sub-system 806 may use various algorithms to train a machine learning model using sample and/or live data. Additionally, a machine learning sub-system 806 may update the machine learning model as new data is received. In another example, the machine learning sub-system 806 may train and/or update various artificial intelligence systems or generate, train and/or update various computational models. For example, a computational model of the profile of the member 812 may be generated, trained and/or updated by the machine learning sub-system 806 as new information is received about the member 812.

In an embodiment, after the profile of the member 812 and/or a computational model of the profile of the member 812 has been updated over a period of time (e.g., six months, a year, etc.) and/or over a set of tasks (e.g., twenty tasks, thirty tasks, etc.), systems of the task facilitation service 802 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 802 (e.g., a task recommendation system) can automatically communicate with the member 812 to obtain any additional information needed and can also generate proposals that may be presented to the member 812 for performance of these tasks.

In the example illustrated in FIG. 8, communications between the member 812 and the task facilitation service 802 may be routed to one or more entities within the task facilitation service 802. The example illustrated in FIG. 8 shows a communication router 814 (referred to in the illustration as a “router”) however, as may be contemplated and as illustrated in FIG. 8, the router 814 is an abstract representation of one or more techniques for routing communications between entities. Accordingly, communications from the member 812 to the task facilitation service 802 may be routed to one or more entities of the task facilitation service and communications from the one or more entities of the task facilitation service 802 may be routed back to the member 812.

In the example illustrated in FIG. 8, the representatives 804 can monitor communications between task facilitation service systems and/or sub-systems 808 and the member 812 to ensure that the interaction maintains a positive polarity as described herein because the communications can be routed 816 to the representatives 804 and also routed 818 to task facilitation service systems and/or sub-systems 808. For example, if a member 812 is interacting with the task recommendation system, the representatives 804 can determine whether the member 812 is satisfied with the interaction. If the representatives 804 determine that the conversation has a negative polarity (e.g., that the member 812 is not satisfied with the interaction), the representatives 804 may intervene to improve the interaction.

Similarly, other interactions between task facilitation service systems and/or sub-systems 808 and the member 812 may be routed 820 to a member communication sub-system 822 which may be configured to monitor the interactions between task facilitation service systems and/or sub-systems 808 and the member 812. In an embodiment, the member communication sub-system 822 can be configured to intercept the interactions between task facilitation service systems and/or sub-systems 808 and the member 812 (using, for example, the router 814). In such an embodiment, all such interactions can be routed 820 between the member 812 and the member communication sub-system 822 and can be routed 824 between the member communication sub-system 822 and the task facilitation service systems and/or sub-systems 808. In such an embodiment, interactions between the task facilitation service systems and/or sub-systems 808 and the member 812 may not be routed 818 directly. In such an embodiment, the representatives 804 may still monitor interactions between task facilitation service systems and/or sub-systems 808 and the member 812 to ensure that the interaction maintains a positive polarity as described above (e.g., by routing 816 the interactions to the representatives 804).

In an embodiment, the representatives 804 can interact with the machine learning sub-system 806 to update the profile of the member indicating changing member preferences based on an interaction between the representatives 804 the member 812. In an embodiment, the task facilitation service systems and/or sub-systems 808 can interact with the machine learning sub-system 806 to update the profile of the member when, for example, a proposal is accepted or rejected. Additionally, as illustrated in FIG. 8, the interactions between the task facilitation service 802 and the member 812 can be additionally routed 826 between the member communication sub-system 822 and the machine learning sub-system 806. Accordingly, interactions between the member 812 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 808 can update the profile of the member 812 and/or a computational model of the profile of the member 812 continuously, dynamically, automatically, and/or in real-time. For example, task facilitation service systems and/or sub-systems 808 can update the profile of the member 812 and/or a computational model of the profile of the member 812 using the machine learning sub-system 806 as described herein. Accordingly, task facilitation service systems and/or sub-systems 808 can update the profile of the member 812 and/or a computational model of the profile of the member 812 to provide up-to-date information about the member based on the member's automatic interaction with the task facilitation service 802, based on the member's interaction with the representative 804, and/or based on tasks performed on behalf of the member 812 over time. This information may also be updated continuously, automatically, dynamically, and/or in real-time as tasks and/or proposals are created, proposed, and performed for the member 812. This information may also be used by the task facilitation service 802 to anticipate, identify, and present appropriate or intelligent interactions with the member 812 (e.g., in response to member 812 queries, needs, and/or goals).

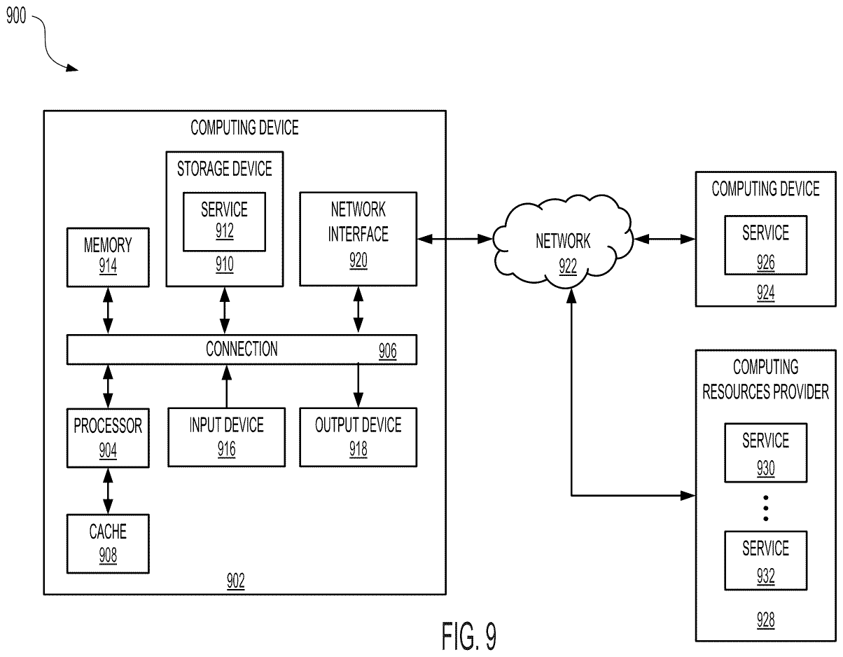

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In an embodiment, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed processed for generating and executing experience recommendations can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM

(PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described above, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IOT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 7-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
detecting through a graphical user interface a request to generate an automated agent, wherein the request includes a graphical representation of a set of nodes and a set of connections amongst the set of nodes, wherein the set of nodes corresponds to different machine learning models and a set of functions performable by the different machine learning models, and wherein the set of connections defines processing paths of the automated agent;
dynamically converting the graphical representation of the set of nodes and the set of connections into programmatic code;
executing the programmatic code to evaluate a performance of the different machine learning models in processing the set of functions according to the processing paths;
updating the graphical user interface according to the performance of the different machine learning models;
detecting through the graphical user interface to implement the automated agent according to the graphical representation of the set of nodes and the set of connections;
converting the programmatic code into a configuration file; and
exposing an application programming interface (API) endpoint corresponding to the configuration file, wherein the API endpoint is exposed through a runtime environment (RTE), and wherein the RTE processes API calls to the API endpoint to execute the automated agent according to the configuration file, the set of functions, and the processing paths.

2. The computer-implemented method of claim 1, further comprising:
detecting one or more errors corresponding to the performance of the different machine learning models; and
dynamically updating the graphical user interface to present the one or more errors.

3. The computer-implemented method of claim 1, further comprising:
receiving a request to test the automated agent according to the graphical representation of the set of nodes and the set of connections;
updating the graphical user interface to provide an agent interface environment, wherein the agent interface environment is generated according to the programmatic code; and
providing automated agent outputs and intermediate agent operations according to inputs received through the agent interface environment.

4. The computer-implemented method of claim 1, wherein the request further includes a set of intermediate prompts, and wherein the set of intermediate prompts is used as input to the different machine learning models to perform the set of functions.

5. The computer-implemented method of claim 1, wherein the set of connections is defined through the graphical user interface according to different outputs generated by the different machine learning models.

6. The computer-implemented method of claim 1, further comprising:
identifying a set of available machine learning models for defining different nodes through the graphical user interface;
detecting a request to add a new node to the graphical representation of the set of nodes; and
updating the graphical user interface to indicate the set of available machine learning models, wherein when a machine learning model is selected from the set of available machine learning models, the machine learning model is associated with the new node.

7. The computer-implemented method of claim 1, further comprising:
receiving a request to evaluate the programmatic code; and
updating the graphical user interface to present the programmatic code, wherein when a modification to the programmatic code made through the graphical user interface, the graphical representation of the set of nodes and the set of connections is dynamically updated according to the modification.

8. A system, comprising:
one or more processors; and
memory storing thereon instructions that, as a result of being executed by the one or more processors, cause the system to:
detect through a graphical user interface a request to generate an automated agent, wherein the request includes a graphical representation of a set of nodes and a set of connections amongst the set of nodes, wherein the set of nodes corresponds to different machine learning models and a set of functions performable by the different machine learning models, and wherein the set of connections defines processing paths of the automated agent;
dynamically convert the graphical representation of the set of nodes and the set of connections into programmatic code;
execute the programmatic code to evaluate a performance of the different machine learning models in processing the set of functions according to the processing paths;
update the graphical user interface according to the performance of the different machine learning models;
detect through the graphical user interface to implement the automated agent according to the graphical representation of the set of nodes and the set of connections;
convert the programmatic code into a configuration file; and
expose an application programming interface (API) endpoint corresponding to the configuration file, wherein the API endpoint is exposed through a runtime environment (RTE), and wherein the RTE processes API calls to the API endpoint to execute the automated agent according to the configuration file, the set of functions, and the processing paths.

9. The system of claim 8, wherein the instructions further cause the system to:
detect one or more errors corresponding to the performance of the different machine learning models; and
dynamically update the graphical user interface to present the one or more errors.

10. The system of claim 8, wherein the instructions further cause the system to:
receive a request to test the automated agent according to the graphical representation of the set of nodes and the set of connections;
update the graphical user interface to provide an agent interface environment, wherein the agent interface environment is generated according to the programmatic code; and
provide automated agent outputs and intermediate agent operations according to inputs received through the agent interface environment.

11. The system of claim 8, wherein the request further includes a set of intermediate prompts, and wherein the set of intermediate prompts is used as input to the different machine learning models to perform the set of functions.

12. The system of claim 8, wherein the set of connections is defined through the graphical user interface according to different outputs generated by the different machine learning models.

13. The system of claim 8, wherein the instructions further cause the system to:
identify a set of available machine learning models for defining different nodes through the graphical user interface;
detect a request to add a new node to the graphical representation of the set of nodes; and
update the graphical user interface to indicate the set of available machine learning models, wherein when a machine learning model is selected from the set of available machine learning models, the machine learning model is associated with the new node.

14. The system of claim 8, wherein the instructions further cause the system to:
receive a request to evaluate the programmatic code; and
update the graphical user interface to present the programmatic code, wherein when a modification to the programmatic code made through the graphical user interface, the graphical representation of the set of nodes and the set of connections is dynamically updated according to the modification.

15. A non-transitory computer-readable storage medium storing thereon executable instructions that, as a result of being executed by one or more processors of a computer system, cause the computer system to:
detect through a graphical user interface a request to generate an automated agent, wherein the request includes a graphical representation of a set of nodes and a set of connections amongst the set of nodes, wherein the set of nodes corresponds to different machine learning models and a set of functions performable by the different machine learning models, and wherein the set of connections defines processing paths of the automated agent;
dynamically convert the graphical representation of the set of nodes and the set of connections into programmatic code;
execute the programmatic code to evaluate a performance of the different machine learning models in processing the set of functions according to the processing paths;
update the graphical user interface according to the performance of the different machine learning models;
detect through the graphical user interface to implement the automated agent according to the graphical representation of the set of nodes and the set of connections; and
convert the programmatic code into a configuration file; and
expose an application programming interface (API) endpoint corresponding to the configuration file, wherein the API endpoint is exposed through a runtime environment (RTE), and wherein the RTE processes API calls to the API endpoint to execute the automated agent according to the configuration file, the set of functions, and the processing paths.

16. The non-transitory computer-readable storage medium of claim 15, wherein the executable instructions further cause the computer system to:
detect one or more errors corresponding to the performance of the different machine learning models; and
dynamically update the graphical user interface to present the one or more errors.

17. The non-transitory computer-readable storage medium of claim 15, wherein the executable instructions further cause the computer system to:
receive a request to test the automated agent according to the graphical representation of the set of nodes and the set of connections;
update the graphical user interface to provide an agent interface environment, wherein the agent interface environment is generated according to the programmatic code; and
provide automated agent outputs and intermediate agent operations according to inputs received through the agent interface environment.

18. The non-transitory computer-readable storage medium of claim 15, wherein the request further includes a set of intermediate prompts, and wherein the set of intermediate prompts is used as input to the different machine learning models to perform the set of functions.

19. The non-transitory computer-readable storage medium of claim 15, wherein the set of connections is defined through the graphical user interface according to different outputs generated by the different machine learning models.

20. The non-transitory computer-readable storage medium of claim 15, wherein the executable instructions further cause the computer system to:
identify a set of available machine learning models for defining different nodes through the graphical user interface;
detect a request to add a new node to the graphical representation of the set of nodes; and
update the graphical user interface to indicate the set of available machine learning models, wherein when a machine learning model is selected from the set of available machine learning models, the machine learning model is associated with the new node.

21. The non-transitory computer-readable storage medium of claim 15, wherein the executable instructions further cause the computer system to:
receive a request to evaluate the programmatic code; and
update the graphical user interface to present the programmatic code, wherein when a modification to the programmatic code made through the graphical user interface, the graphical representation of the set of nodes and the set of connections is dynamically updated according to the modification.
